(19) United States
(12) Patent Application Publication
(10) Pub. No.: US 2025/0340367 A1
(43) Pub. Date: Nov. 6, 2025

(54) REFUSE CART DETECTION SYSTEMS AND METHODS

(71) Applicant: Oshkosh Corporation, Oshkosh, WI (US)

(72) Inventors: Leo Van Kampen, Conestogo (CA); Vince Schad, Oshkosh, WI (US); Johnny Bui, Oshkosh, WI (US); Brendan Chan, Oshkosh, WI (US)

(73) Assignee: Oshkosh Corporation, Oshkosh, WI (US)

(21) Appl. No.: 19/197,042

(22) Filed: May 2, 2025

Related U.S. Application Data
(60) Provisional application No. 63/642,324, filed on May 3, 2024.

(51) Int. Cl. B65F 3/04; B25J 9/16; B65F 3/02

(52) U.S. Cl. CPC B65F 3/041; B25J 9/1666; B65F 2003/0269; B65F 2003/0283

(57) ABSTRACT

A system for detecting and engaging a refuse cart includes a sensor coupled to a refuse vehicle and configured to generate sensor data indicative of objects on one or more sides of the refuse vehicle; a grabber assembly coupled to the refuse vehicle and comprising actuator arms that are configured to engage the refuse cart; and a controller. The controller is configured to detect a location of a refuse cart based on data from the sensor, detect a location of an obstruction in a vicinity of the refuse cart based on the data, and modify a collection routine associated with operation of the actuator arms based on the location of the refuse cart and the location of the obstruction.

### CROSS-REFERENCE TO RELATED APPLICATIONS

This application claims the benefit of and priority to U.S. Provisional Patent Application No. 63/642,324, filed May 3, 2024, the entire contents of which are hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment relates to a system for detecting and engaging a refuse cart. The system includes a sensor, a grabber assembly, and a controller. The sensor is coupled to a refuse vehicle and is configured to generate sensor data indicative of objects on one or more sides of the refuse vehicle. The grabber assembly is coupled to the refuse vehicle and includes actuator arms that are configured to engage the refuse cart. The controller is communicably coupled to the sensor and the grabber assembly and is configured to: detect a location of a refuse cart based on the sensor data; detect a location of an obstruction in a vicinity of the refuse cart based on the sensor data; and modify a collection routine associated with operation of the actuator arms based on the location of the refuse cart and the location of the obstruction.

Another embodiment relates to a system for detecting and engaging a refuse cart. The system includes a sensor, a grabber assembly, and a controller. The sensor is coupled to a refuse vehicle and is configured to generate sensor data indicative of objects on one or more sides of the refuse vehicle. The grabber assembly is coupled to the refuse vehicle and includes actuator arms that are configured to engage the refuse cart. The controller is communicably coupled to the sensor and the grabber assembly and is configured to: detect a location of a refuse cart based on the sensor data; determine a condition of the refuse cart based on the sensor data; and modify a collection routine associated with operation of the actuator arms based on the location of the refuse cart and the condition of the refuse cart.

Another embodiment relates to a system for detecting and engaging a refuse cart. The system includes a sensor, a lift assembly, and a controller. The sensor is coupled to a refuse vehicle and is configured to generate sensor data indicative of objects on one or more sides of the vehicle. The lift assembly is coupled to the refuse vehicle and includes a grabber assembly including actuator arms that are configured to engage the refuse cart; and a lateral actuator configured to adjust a lateral position of the grabber assembly relative to the refuse vehicle. The controller is communicably coupled to the sensor and the lift assembly and is configured to: determine, based on the sensor data, a first collection parameter including at least one of a width of the refuse cart, an orientation of the refuse cart, an alignment of the refuse cart with the grabber assembly, or a first obstruction in a vicinity of the refuse cart; control the grabber assembly to adjust a distance between the actuator arms based on the at least one first collection parameter; and after causing the grabber assembly to adjust the distance, causing the lateral actuator to move the grabber assembly away from the refuse vehicle to engage the refuse cart.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1A is a perspective view of a side-loading refuse vehicle, according to an embodiment.

FIG. 1B is a perspective view of a front-loading refuse vehicle, according to an embodiment.

FIG. 2 is a perspective view of a first type of actuator assembly that may be used with the refuse vehicles of FIGS. 1A and 1B, according to an embodiment.

FIG. 3 is a perspective view of a second type of actuator assembly that may be used with the refuse vehicles of FIG. 1A and 1B, according to an embodiment.

FIG. 4 is a block diagram of a controller for use with a refuse vehicle, according to an embodiment.

FIG. 5 is a flow diagram of a method for initiating control actions based on a detected refuse cart, according to an embodiment.

FIG. 6A is a top view of a refuse vehicle in the process of engaging an obstructed refuse cart, according to an embodiment.

FIG. 6B is a top view of a refuse vehicle in the process of engaging an unobstructed refuse cart, according to an embodiment.

FIG. 7A is a top view of a grabber assembly in the process of engaging a refuse cart that is aligned with the grabber assembly, according to an embodiment.

FIG. 7B is t top view of a grabber assembly in the process of engaging a refuse cart that is aligned with the grabber assembly, according to another embodiment.

FIG. 7C is a top view of a grabber assembly in the process of engaging a refuse cart that is rotated out of alignment relative to the grabber assembly, according to an embodiment.

FIG. 7D is a top view of a grabber assembly in the process of engaging a refuse cart that is offset relative to the grabber assembly, according to an embodiment.

FIG. 8 is a flow diagram of a method for initiating control actions based on a detected refuse cart, according to an embodiment.

FIG. 9A is a front view of a refuse cart in an unobstructed condition, according to an embodiment.

FIG. 9B is a front view of a refuse cart in a partially obstructed condition, according to an embodiment.

FIG. 10A is a front view of a refuse cart with a closed lid, according to an embodiment.

FIG. 10B is a front view of a refuse cart with an open lid, according to an embodiment.

FIG. 11 is a flow diagram of a method for initiating control actions based on a detected refuse cart, according to an embodiment.

FIG. 12A is a top view of a grabber assembly in the process of engaging an unobstructed refuse cart, according to an embodiment.

FIG. 12B is a top view of a grabber assembly in the process of engaging an obstructed refuse cart, according to an embodiment.

FIG. 13 is a flow diagram of a method for initiating control actions based on a detected refuse cart, according to an embodiment.

FIG. 14 is a front view of an overfilled refuse cart, according to an embodiment.

FIG. 15 is a front view of a refuse cart experiencing a thermal event, according to an embodiment.

FIG. 16 is a flow diagram of a method for initiating control actions based on a detected refuse cart, according to an embodiment.

FIG. 17 is a flow diagram of a method for initiating control actions based on a detected refuse cart, according to an embodiment.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Referring generally to the figures, systems and methods for detecting the condition of a refuse cart (e.g., a refuse cart, a refuse container, etc.) are shown, according to various embodiments. In some embodiments, the refuse cart detection systems include a controller configured to receive and process data from a plurality of cameras and/or sensors coupled to a refuse vehicle. The refuse vehicle may be a garbage truck, a waste collection truck, a sanitation truck, etc., configured for receiving refuse material from the refuse cart. The refuse vehicle may include a side-loading refuse vehicle, a front-loading refuse vehicle, a a rear-loading refuse vehicle, and/or another loading arrangement. The plurality of cameras and/or sensors (e.g., LIDAR, radar, etc.) and the controller may be disposed in any suitable location on the refuse vehicle. The controller may process data from the cameras and/or sensors to detect and/or determine the presence, location, and condition (e.g., an orientation and/or position relative to the refuse vehicle, etc.) of refuse carts, as well as the presence and location of other objects near the refuse carts. The presence, location, and condition of an identified refuse cart may be used to navigate the refuse vehicle and/or control an actuator assembly of the refuse vehicle to engage the refuse cart, which can reduce and/or eliminate the need for an operator to manually reposition the refuse cart relative to the refuse vehicle, or portions thereof. Such systems and methods as described herein can also reduce and/or eliminate the need for an operator to interact with obstacles near the refuse cart, such as other refuse carts, mailboxes, and/or other items. As denoted herein, a refuse cart may include any type of residential, commercial, or industrial refuse container.

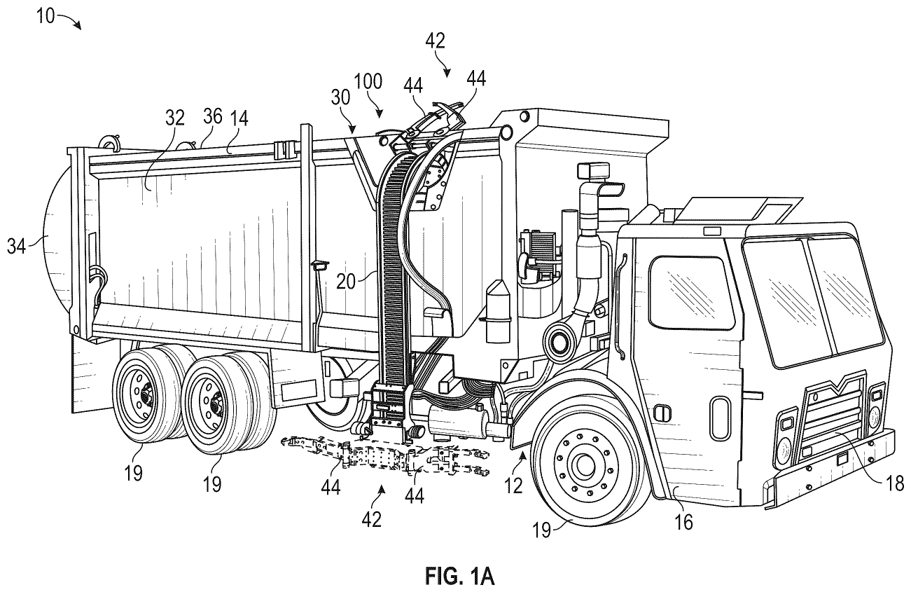

Referring now to FIGS. 1A and 1B, a refuse vehicle 10 is shown, according to some embodiments. The refuse vehicle 10 may be a garbage truck, a waste collection truck, a sanitation truck, etc., and may be configured as a side-loading refuse truck (e.g., as shown in FIG. 1A), front-loading refuse truck (e.g., as shown in FIG. 1B), or a rear-loading refuse truck in which refuse materials are loaded from a rear end of the refuse vehicle, opposite a cab. In other embodiments, refuse vehicle 10 is another type of vehicle (e.g., a skid-loader, a telehandler, a plow truck, a boom lift, etc.).

As shown, the refuse vehicle 10 includes a chassis, shown as frame 12; a body assembly, shown as a body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator, such as a seat, a steering wheel, hydraulic controls, a graphical user interface (e.g., a touchscreen user interface), switches, buttons, dials, etc.

As shown, the refuse vehicle 10 includes a prime mover, shown as engine 18, coupled to the frame 12 at a position beneath the cab 16. The engine 18 is configured to provide power to a series of tractive elements, shown as wheels 19, and/or to other systems of refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from an on-board storage device (e.g., batteries, ultracapacitors, etc.), from an on-board generator (e.g., an internal combustion engine, etc.), and/or from an external power source (e.g., overhead power lines, etc.) and provide power to the systems of the refuse vehicle 10.

In some embodiments, the refuse vehicle 10 is configured to transport refuse from various waste receptacles within a municipality to a storage and/or processing facility (e.g., a landfill, an incineration facility, a recycling facility, etc.). As shown, the body 14 includes a plurality of panels, shown as panels 32, a tailgate 34, and a cover 36. In some embodiments, as shown in FIG. 1B, the body 14 further includes a door, shown as top door 38, which is movably coupled along the cover 36 to seal the opening thereby preventing refuse from escaping the refuse compartment 30 (e.g., due to wind, bumps in the road, etc.). The panels 32, the tailgate 34, the cover 36, and/or the top door 38 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. In some embodiments, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (i.e., refuse is loaded into a position of the refuse compartment 30 behind the cab 16 and stored in a position further toward the rear of the refuse compartment 30). In other embodiments, the storage volume is positioned between the hopper volume and the cab 16 (e.g., a rear-loading refuse vehicle, etc.).

As shown in FIG. 1A, the refuse vehicle 10, when configured as a side-loading refuse vehicle, may include a side-loading lift mechanism/system (i.e., a side-loading lift assembly), shown as lift assembly 100 coupled to the refuse vehicle 10 (e.g., to the body 14 of the refuse vehicle 10). Lift assembly 100 includes a grabber assembly, shown as grabber assembly 42, slidably coupled to a guide, shown as track 20, and configured to move along an entire length of the track 20. The track 20 is shown to extend along substantially an entire height of the body 14 and is configured to cause the grabber assembly 42 to tilt or rotate near an upper height of the body 14. In other embodiments, the track 20 extends along substantially an entire height of the body 14 on a rear side of the body 14.

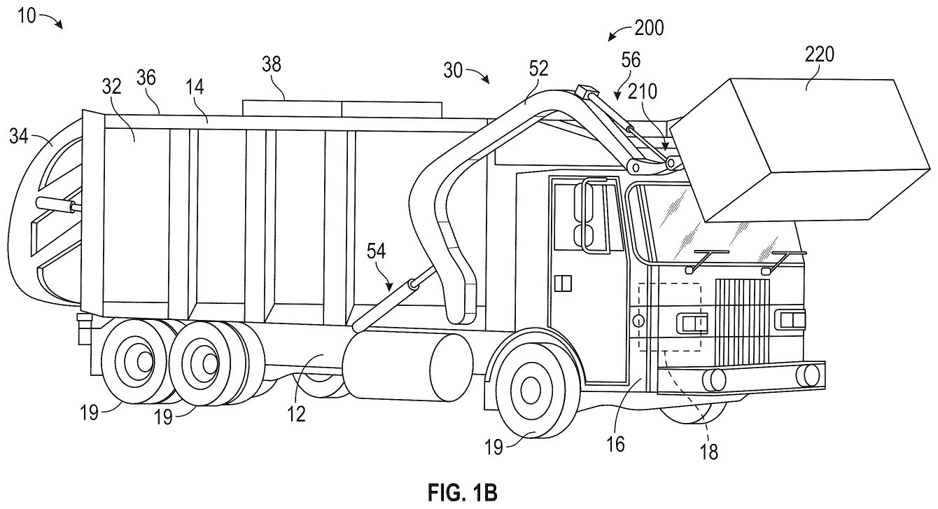

The grabber assembly 42 is shown to include a pair of actuators, shown as actuators 44 (e.g., fingers, arms, actuator arms, grabbers, etc.). The grabber assembly 42 is configured to actuate to engage a refuse cart with the actuators 44. For example, the actuators 44 are configured to releasably secure the refuse container to grabber assembly 42, according to an exemplary embodiment. The actuators 44 are selectively repositionable (e.g., individually, simultaneously, etc.) between an engaged position or state and a disengaged position or state. In the engaged position, the actuators 44 are rotated towards one other such that the refuse container may be grasped therebetween. In the disengaged position, the actuators 44 rotate outwards (e.g., as shown in FIG. 2) such that the refuse container is not grasped by the actuators 44. By transitioning between the engaged position and the disengaged position, the actuators 44 releasably couple the refuse container to the grabber assembly 42.

In operation, the refuse vehicle 10 may pull up alongside the refuse container, such that the refuse container is positioned to be grasped by the grabber assembly 42 therein. The grabber assembly 42 may then transition into an engaged state to grasp the refuse container. After the refuse container has been securely grasped, the grabber assembly 42 may be transported along the track 20 (e.g., by an actuator) with the refuse container. When the grabber assembly 42 reaches the end of the track 20, the grabber assembly 42 may tilt and empty the contents of the refuse container into the refuse compartment 30. The tilting is facilitated by the path of the track 20. When the contents of the refuse container have been emptied into the refuse compartment 30, the grabber assembly 42 may descend along the track 20 and return the refuse container to the ground. Once the refuse container has been placed on the ground, the grabber assembly 42 may transition into the disengaged state, releasing the refuse container.

As shown in FIG. 1B, the refuse vehicle 10, when configured as a front-loading refuse vehicle, may include a lift mechanism/system (e.g., a front-loading lift assembly), shown as lift assembly 200. The lift assembly 200 includes a pair of arms, shown as lift arms 52, coupled to the frame 12 and/or the body 14 on either side of the refuse vehicle 10 such that the lift arms 52 extend forward of the cab 16 (e.g., a front-loading refuse vehicle, etc.). In other embodiments, the lift assembly 200 extends rearward of the body 14 (e.g., a rear-loading refuse vehicle, etc.). In still other embodiments, the lift assembly 200 extends from a side of the body 14 (e.g., a side-loading refuse vehicle, etc.). The lift arms 52 may be rotatably coupled to frame 12 with a pivot (e.g., a lug, a shaft, etc.). As shown, the lift assembly 200 includes a first lift actuator assembly, shown as lift arm actuators 54 (e.g., hydraulic cylinders, etc.), coupled to the frame 12 and the lift arms 52. The lift arm actuators 54 are positioned such that extension and retraction thereof rotates the lift arms 52 about an axis extending through the pivot, according to an exemplary embodiment.

An attachment assembly 210 may be coupled to the lift arms 52 of the lift assembly 200. As shown, the attachment assembly 210 is configured to engage with a first attachment, shown as container attachment 220, to selectively and releasably secure the container attachment 220 to the lift assembly 200. In some embodiments, the attachment assembly 210 may be configured to engage with a second attachment, such as a fork attachment, to selectively and releasably secure the second attachment to the lift assembly 200. In various embodiments, the attachment assembly 210 may be configured to engage with another type of attachment (e.g., a street sweeper attachment, a snow plow attachment, a snowblower attachment, a towing attachment, a wood chipper attachment, a bucket attachment, a cart tipper attachment, a grabber attachment, etc.).

As shown in FIG. 1B, the lift arms 52 are rotated by the lift arm actuators 54 to lift the container attachment 220 or other attachment over the cab 16. Lift assembly 200 includes second actuators, shown as articulation actuators 56 (e.g., hydraulic cylinders, etc.). In some embodiments, the articulation actuators 56 are positioned to articulate the attachment assembly 210. Such articulation may assist in tipping refuse out of the container attachment 220 and/or a refuse container (e.g., coupled to the lift assembly 200 by a fork attachment, etc.) and into the hopper volume of the refuse compartment 30 through an opening in the cover 36. The lift arm actuators 54 may thereafter rotate the lift arms 52 to return the empty container attachment 220 to the ground. In some embodiments, top door 38 is movably coupled along the cover 36 to seal the opening thereby preventing refuse from escaping the refuse compartment 30 (e.g., due to wind, bumps in the road, etc.).

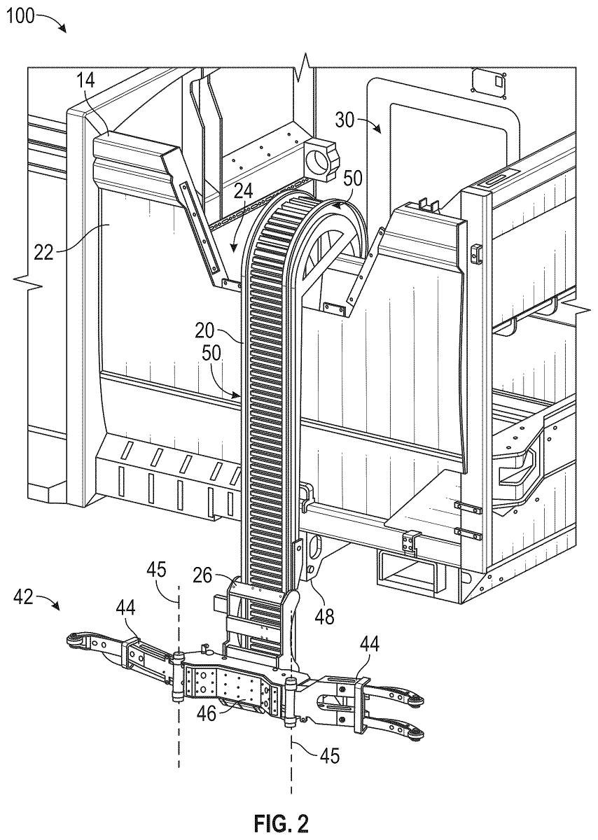

Referring now to FIGS. 2 and 3, detailed perspective views of lift assemblies for use with refuse truck 10 are shown, according to some embodiments. Specifically, FIG. 2 shows a detailed, perspective view of the lift assembly 100, according to an embodiment. As described briefly above, the lift assembly 100 includes a lift actuator assembly 50, including a track 20, and grabber assembly 42, which includes a frame, chassis, or connecting member, shown as carriage 26, connecting the grabber assembly 42 the track 20. The track 20 extends along substantially the entire height of the body 14, according to the exemplary embodiment shown. The lift actuator assembly 50 is configured to adjust the height or vertical position of the grabber assembly 42 to engage a refuse container and to lift the refuse container by moving the grabber assembly 42 along the track 20. The lift actuator assembly 50 and the grabber assembly 42 may be configured to translate relative to the side of the body 14 of the refuse vehicle 10, so that the grabber assembly 42 may be moved toward a refuse container adjacent the refuse vehicle 10 to engage the refuse container. The lift assembly 100 may include a lateral actuator 48 for controlling the lateral position of the lift actuator assembly 50 and the grabber assembly 42.

The body 14 includes a panel, shown as loading section 22, that defines a cutout or notch, shown as recess 24, through which the track 20 passes. The recess 24 facilitates a curved portion of the track 20 extending around the top of the loading section 22 without increasing the overall height of the vehicle 10. When the grabber assembly 42 moves along the curved portion of the track 20, the grabber assembly 42 is inverted to empty the refuse container releasably coupled to the grabber assembly 42 into the refuse compartment 30. The carriage 26 is slidably coupled to the track 20. In operation, the carriage 26 may translate along a portion or all of the length of the track 20. The carriage 26 is removably coupled (e.g., by removable fasteners) to a body or frame of the grabber assembly 42, shown as grabber frame 46. Alternatively, the grabber frame 46 may be fixedly coupled to (e.g., welded to, integrally formed with, etc.) the carriage 26. The actuators 44 are each pivotally coupled to the grabber frame 46 such that they rotate about a pair of axes 45. The axes 45 extend substantially parallel to one another and are longitudinally offset from one another. In some embodiments, one or more actuators configured to rotate the actuators 44 between the engaged state and the disengaged state are coupled to the grabber frame 46 and/or the carriage 26.

Referring now to FIG. 3, a detailed, perspective view of a lift assembly 200 including a container attachment 220 is shown, according to an embodiment. As shown, the container attachment 220 includes a container, shown as refuse container 202; an articulating refuse collection arm, shown as collection arm assembly 270; and an interface, shown as attachment interface 280. The refuse container 202 has a first wall, shown as front wall 212; an opposing second wall, shown as rear wall 214 (e.g., positioned between the cab 16 and the front wall 212, etc.); a first sidewall, shown as first sidewall 230; an opposing second sidewall, shown as second sidewall 240; and a bottom surface, shown as bottom 250. The front wall 212, the rear wall 214, the first sidewall 230, the second sidewall 240, and the bottom 250 cooperatively define an internal cavity, shown as container refuse compartment 260. According to an exemplary embodiment, the container refuse compartment 260 is configured to receive refuse from a refuse container (e.g., a residential garbage can, a recycling bin, etc.).

As shown, the second sidewall 240 of the refuse container 202 defines a cavity, shown as recess 242. The collection arm assembly 270 is coupled to the refuse container 202 and may be positioned within the recess 242. In other embodiments, the collection arm assembly 270 is otherwise positioned (e.g., coupled to the rear wall 214, coupled to the first sidewall 230, coupled to the front wall 212, etc.). According to an exemplary embodiment, the collection arm assembly 270 includes an arm, shown as arm 272; a grabber assembly, shown as grabber 276, coupled to an end of the arm 272; and an actuator, shown as actuator 274. The actuator 274 may be positioned to selectively reorient the arm 272 such that the grabber 276 is extended laterally outward from and retracted laterally inward toward the refuse container 202 to engage (e.g., pick up, etc.) a refuse container (e.g., a garbage can, a reclining bin, etc.) for emptying refuse into the container refuse compartment 260.

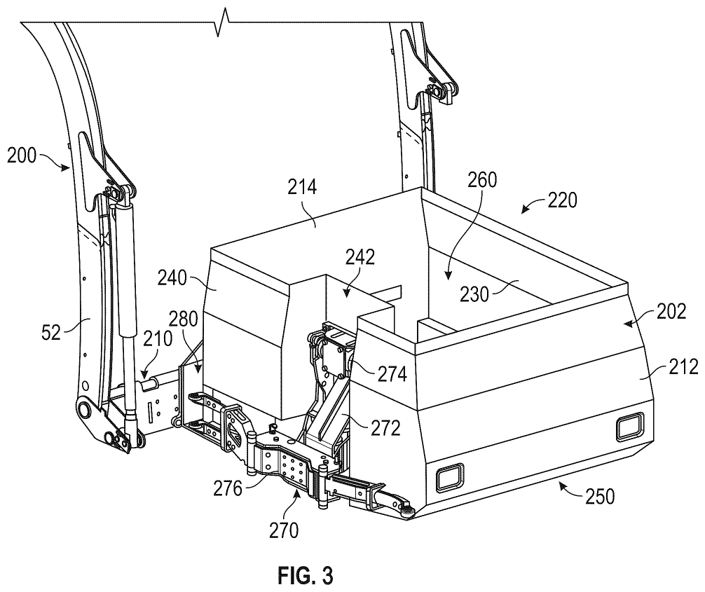

Referring now to FIG. 4, a controller 400 for refuse vehicle 10 is shown, according to an embodiment. It will be appreciated that controller 400 may be implemented via single controller or may be implemented across multiple controllers or devices. Controller 400 may be configured to receive data from image and/or object sensors 430 (i.e., cameras and sensors) to detect and/or track a plurality of refuse carts and other objects located on any side of a refuse vehicle (e.g., the front, sides, or rear of refuse vehicle 10). The object sensors 430 may be coupled to the refuse vehicle 10 (e.g., to the body 14 of the refuse vehicle 10) and may be configured to detect objects on one or more sides of the refuse vehicle (e.g., objects adjacent and/or proximate to the refuse vehicle, objects within a vicinity of the refuse vehicle, etc.). The controller 400 may be configured to detect a location of a refuse cart based on data from the object sensors 430 (e.g., sensor data). The controller 400 may also be configured to detect other objects or obstructions in a vicinity of the refuse cart (e.g., adjacent to the refuse cart, within a range of movement of the actuator arms 44 when the actuator arms are engaged with the refuse cart, etc.) that may obstruct the ability of the grabber assembly 42 to engage the refuse cart. Controller 400 may be further configured to initiate automated control actions based on the detection of a location of the refuse cart, and in some embodiments, collection parameters including the orientation of the refuse cart, the size of the refuse cart, the alignment of the refuse cart with the grabber assembly 42, the location of obstructions in the vicinity of the refuse cart, the position of the lid of the refuse cart, a fill level of the refuse cart, or a thermal event in the refuse cart. The controller 400 may modify a collection routine (e.g., a collection routine that is associated with the actuator arms 44) based on the detected collection parameters. For example, the controller 400 may cause the lift assembly 100 to adjust the distance between the actuator arms 44 before engaging the refuse cart, may adjust the height of the grabber assembly 42 before engaging the refuse cart, or may adjust the distance that the lateral actuator 48 moves the grabber assembly 42 toward the refuse cart.

For example, as described in further detail below, before causing the lateral actuator 48 to move the grabber assembly 42 away from the refuse vehicle 10 to engage the refuse cart, the controller 400 may cause the cause the lift actuator assembly 100 to adjust a distance between the actuator arms 44 based on at least one first collection parameter detected based on sensor data (e.g., from the object sensors 430) including at least one of a width of the refuse cart, an orientation of the refuse cart, an alignment of the refuse cart with the grabber assembly, or a first obstruction in a vicinity of the refuse cart. In some embodiments, the controller 400, before causing the lateral actuator 48 to move the grabber assembly 42 away from the refuse vehicle 10 to engage the refuse cart, may further cause the cause the lift actuator assembly 100 to adjust the vertical position of the grabber assembly 42 based on at least one second collection parameter detected based on the sensor data including at least one of one or more obstruction in the vicinity of the refuse cart or a lid of the refuse cart in an open position. In some embodiments, the controller 400 may determine a lateral distance to move the grabber assembly 42 away from the refuse vehicle 10 based on the location of the refuse cart and at least one third collection parameter including one or more detected obstructions behind the refuse cart.

Controller 400 may be one of one or more controllers of refuse vehicle 10, for example. Controller 400 generally receives and processes data from one or more image and/or object sensors 430 disposed at various locations of refuse vehicle 10 to identify refuse carts located on at least the curb side of refuse vehicle 10. Controller 400 is shown to include a processing circuit 402 including a processor 404 and a memory 406. In some embodiments, processing circuit 402 is implemented via one or more graphics processing units (GPUs). Processor 404 can be implemented as a general purpose processor, an application specific integrated circuit (ASIC), one or more field programmable gate arrays (FPGAs), a group of processing components, or other suitable electronic processing components. In some embodiments, processor 404 is implemented as one or more graphics processing units (GPUs).

Memory 406 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 406 can be or include volatile memory or non-volatile memory. Memory 406 can include database components, object code components, script components, or any other type of information structure for supporting the various activities and information structures described in the present application. According to an example embodiment, memory 406 is communicably connected to processor 404 via processing circuit 402 and includes computer code for executing (e.g., by processing circuit 402 and/or processor 404) one or more processes described herein.

Processing circuit 402 can be communicably connected to a network interface 408 and an input/output (I/O) interface 410, such that processing circuit 402 and the various components thereof can send and receive data via interfaces 408 and 410. In some embodiments, controller 400 is communicably coupled with a network 440 via network interface 408, for transmitting and/or receiving data from/to network connected devices. Network 440 may be any type of network (e.g., intranet, Internet, VPN, a cellular network, a satellite network, etc.) that allows controller 400 to communicate with other remote systems. For example, controller 400 may communicate with a server (i.e., a computer, a cloud server, etc.) to send and receive information regarding operations of controller 400 and/or refuse vehicle 10.

Network interface 408 may include any type of wireless interface (e.g., antennas, transmitters, transceivers, etc.) for conducting data communications with network 440. In some embodiments, network interface 408 includes a cellular device configured to provide controller 400 with Internet access by connecting controller 400 to a cellular tower via a 2G network, a 3G network, an LTE network, etc. In some embodiments, network interface 408 includes other types of wireless interfaces such as Bluetooth, WiFi, Zigbee, etc.

In some embodiments, controller 400 may receive over-the-air (OTA) updates or other data from a remote system (e.g., a server, a computer, etc.) via network 440. The OTA updates may include software and firmware updates for controller 400, for example. Such OTA updates may improve the robustness and performance of controller 400. In some embodiments, the OTA updates may be received periodically to keep controller 400 up-to-date.

In some embodiments, controller 400 is communicably coupled to any number of subsystems and devices of refuse vehicle 10 via I/O interface 410. I/O interface 410 may include wired or wireless interfaces (e.g., antennas, transmitters, transceivers, wire terminals, etc.) for conducting data communications with subsystems and/or devices of refuse vehicle 10. In some embodiments, I/O interface 410 may include a Controller Area Network (CAN) bus, a Local Interconnect Network (LIN) bus, a Media Oriented Systems Transport (MOST) bus, an SAE J1850 bus, an Inter-Integrated Circuit (I2C) bus, etc., or any other bus commonly used in the automotive industry. As shown, I/O interface 410 may transmit and/or receive data from a plurality of vehicle subsystems and devices including image/object sensors 430, a user interface 432, vehicle systems 434, and/or an actuator assembly 436.

As described herein, image/object sensors 430 may include any type of device that is configured to capture data associated with the detection of objects such as refuse carts. In this regard, image/object sensors 430 may include any type of image and/or object sensors, such as one or more visible light cameras, full-spectrum cameras, LIDAR cameras/sensors, radar sensors, infrared cameras, image sensors (e.g., charged-coupled device (CCD), complementary metal oxide semiconductor (CMOS) sensors, etc.), or any other type of suitable object sensor or imaging device. Data captured by image/object sensors 430 may include, for example, raw image data from one or more cameras (e.g., visible light cameras) and/or data from one or more sensors (e.g., LIDAR, radar, etc.) that may be used to detect objects.

Generally, image/object sensors 430 may be disposed at any number of locations throughout and/or around refuse vehicle 10 for capturing image and/or object data from any direction with respect to refuse vehicle 10. For example, image/object sensors 430 may include a plurality of visible light cameras and LIDAR cameras/sensors mounted on the forward and lateral sides of refuse truck 10 for capturing data as refuse truck 10 moves down a path (e.g., a roadway). In some embodiments, one or more of image/object sensors 430 may be located on an attachment utilized by refuse truck 10, such as container attachment 220 described above.

User interface 432 may be any electronic device that allows a user to interact with controller 400. Examples of user interfaces or devices include, but are not limited to, mobile phones, electronic tablets, laptops, desktop computers, workstations, and other types of electronic devices. In some embodiments, user interface 432 is a control system (i.e., a control panel) configured to display information to an operator of refuse vehicle 10 and/or receive user inputs. In this regard, user interface 432 may include at least a display for presenting information to a user and a user input device for receiving user inputs. In one example, user interface 432 includes a touchscreen display panel located in the cab 16 of refuse truck 10 and configured to present an operator with a variety of information regarding the operations of refuse truck 10. User interface 432 may further include a user input device, such as a keyboard, a joystick, buttons, etc.

Vehicle systems 434 may include any subsystem or device associated with refuse truck 10. Vehicle systems 434 may include, for example, powertrain components (e.g., engine 18), steering components, a grabber arm, lift assemblies, etc. Vehicle system 434 may also include electronic control modules, control units, and/or sensors associated with any systems, subsystems, and/or devices of refuse vehicle 10. For example, vehicle system 434 may include an engine control unit (ECU), a transmission control unit (TCU), a Powertrain Control Module (PCM), a Brake Control Module (BCM), a Central Control Module (CCM), a Central Timing Module (CTM), a General Electronic Module (GEM), a Body Control Module (BCM), an actuator or grabber assembly control module, etc. In this manner, any number of vehicle systems and devices may communicate with controller 400 via I/O interface 410.

Actuator assembly 436 may include at least the components of a lift assembly for engaging, lifting, and emptying a refuse cart. Actuator assembly 436 can include, for example, any of the components of lift assembly 100 and/or lift assembly 200, described above with respect to FIGS. 1A and 1B. In general, actuator assembly 436 may include at least a grabber assembly (e.g., grabber assembly 42) configured to move to engage a refuse cart. Actuator assembly 436 may include a plurality of actuators (e.g., linear actuators, lift actuators, horizontal actuators, etc.) for moving to engage the refuse cart. As an example, actuator assembly 436 may be configured to move horizontally, vertically, orthogonally, etc., to refuse vehicle 10 in order to engage a refuse cart. In some embodiments, actuator assembly 436 may further include an actuator assembly control module, configured to receive data and/or signals from controller 400 to initiate control actions for a grabber arm or actuator.

Still referring to FIG. 4, memory 406 is shown to include an object detector 420. Object detector 420 may generally receive and process data from image/object sensors 430 to detect objects (e.g., refuse carts). It will be appreciated that, as denoted herein, the data received and processed by object detector 420 may include any type of data as described above with respect to image/object sensors 430, including video from which images and/or other image data can be extracted. As described above, the data may also include data from one or more sensors (e.g., LIDAR, radar, etc.) that may be utilized to detect an object (e.g., a refuse cart) and/or a location or position of the object. As shown, for example, object detector 420 may receive data from image/object sensors 430 via I/O interface 410.

Object detector 420 may process the received data to detect target objects, including human beings and/or refuse carts. It will be appreciated, however, that object detector 420 may be configured to detect other objects based on other implementations of controller 400. In this regard, object detector 420 may provide a means for controller 400 to detect and track a plurality of refuse carts on a path being traveled by refuse vehicle 10.

Object detector 420 may include a neural network or other similar model for processing received data (e.g., from image/object sensors 430) to detect target objects. As described herein, object detector 420 is generally a one-stage object detector (e.g., deep learning neural network), or may utilize a one-stage object detection method. Unlike two-stage object detectors (e.g., regional convolution neural network (R-CNN), Fast R-CNN, etc.), object detector 420 may process image data in a single stage and may provide advantages over many two-stage detectors such as increased speed (i.e., decreased computing time).

Referring again to FIG. 4, memory 406 is shown to further include a user interface (UI manager) 422. UI manager 422 may generate a user interface based on data captured by image/object sensors 430 and/or detected object data from object detector 420. UI manager 422 may present a generated user interface via user interface 432, for example. The user interface may include data captured by image/object sensors 430 (e.g., live, delayed, or previously captured image data) and an indication of any detected objects within the data. As an example, the user interface may present an image of a path (e.g., roadway) that refuse truck 10 is traveling on, and may indicate one or more detected refuse carts located along the roadway.

The user interface generated by UI manager 422 may provide means for a user (e.g., an operator of refuse vehicle 10) to interact with refuse vehicle 10 and/or actuator assembly 436 for semi-autonomous or non-autonomous operations. For example, a user interface that indicates two or more refuse carts may provide means for the user to select a particular one of the refuse carts to act on (e.g., to move to and engage). The user interface may also provide other information regarding the operations of refuse vehicle 10, such as alarms, warnings, and or notifications. In some embodiments, the user interface generated by UI manager 422 may include a notification when a human being is detected within a danger zone. This may alert an operator to an unsafe condition and/or may indicate to the operator why automated refuse cart collection cannot be implemented (e.g., until no human beings are located in a danger zone).

Memory 406 is shown to further include a control module 424. Control module 424 may determine and/or implement control actions based on detected objects (e.g., from object detector 420) and/or user inputs (e.g., from user interface 432). In some embodiments, control module 424 may implement any number of automated control actions based on detected objects such as refuse carts and/or human beings. In a first example, control module 424 may implement automated collection of a refuse cart, based on detection of the refuse cart. In this example, once a refuse cart is detected, a location of the refuse cart may be determined using any number of known methods. Based on the determined location of the target refuse cart, control module 424 may determine a trajectory for refuse vehicle 10 and/or actuator assembly 436 in order to engage the refuse cart.

In some embodiments, control module 424 may control (e.g., by transmitting control signals) vehicle systems 434 and/or actuator assembly 436 to move to and engage the refuse cart. For example, control module 424 may transmit control signals to any number of controllers associated with vehicle systems 434 (e.g., the ECU, the TCU, an automated steering system, etc.) in order to move refuse vehicle 10 to a desired position near a refuse cart. In another example, control module 424 may transmit control signals to a controller associated with actuator assembly 436 in order to move/control actuator assembly 436.

Still referring to FIG. 4, memory 406 is shown to further include a feedback module 426. Feedback module 426 may receive data from image/object sensors 430 and/or one or more sensors associated with vehicle systems 434 and/or actuator assembly 436 to adjust and/or alter a trajectory (i.e., movement) of refuse vehicle 10 or actuator assembly 436. In some embodiments, feedback module 426 may process data (e.g., from image/object sensors 430 and/or object detector 420) to adjust and/or alter a trajectory (i.e., movement) of refuse vehicle 10 or actuator assembly 436. In some embodiments, feedback module 426 may include a model for processing feedback data. In some such embodiments, the model may be a recurrent neural network (RNN) or other suitable type of neural network for processing feedback data.

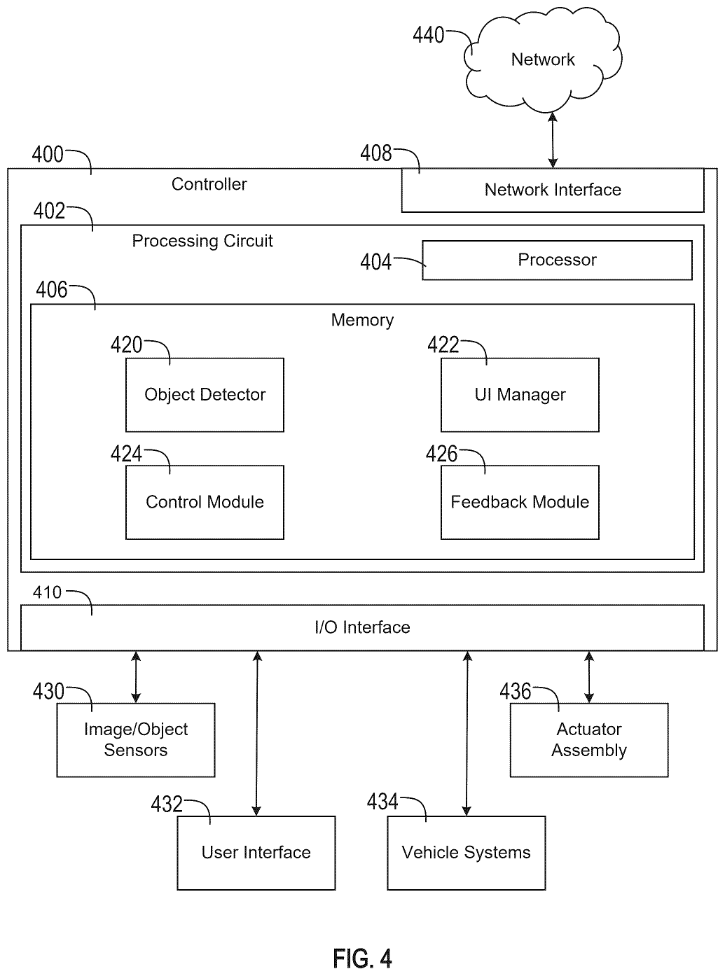

Referring now to FIG. 5, a process 500 for initiating control actions based on a detected refuse cart is shown, according to an embodiment. Process 500 may be implemented in response to detecting a refuse cart and may be implemented by a controller of a refuse vehicle (e.g., refuse vehicle 10), such as the controller 400 described above. As denoted herein, an actuator assembly may refer to any type of grabber and/or lift assembly configured to engage and empty a refuse cart into a refuse container of a refuse vehicle. For example, the actuator assembly may be or include the lift assembly 100 or the lift assembly 200, and the grabber assembly may be or include the grabber assembly 42 or the collection arm assembly 270, as described above.

At step 502, a particular refuse cart is identified. As described above, multiple objects including multiple refuse carts may be detected. In order to initiate a control action, a particular refuse cart may be identified, either automatically or based on a user input. In the first case, where a particular refuse cart is automatically identified in order to initiate a control action, a controller (e.g., controller 400) may evaluate a number of parameters for identifying the particular refuse cart. For example, the refuse cart may be identified based on identifying features (e.g., size, color, shape, logos, or markings, etc.) or may be selected based on its proximity to the refuse vehicle (e.g., the closest refuse cart may be identified first as the particular refuse cart). The particular refuse cart may be automatically identified in autonomous operations (e.g., where refuse vehicle 10 is autonomous) in order to reduce or eliminate operator input.

In some embodiments (e.g., semi-autonomous or non-autonomous operations), the particular refuse cart may be selected by an operator. As described above, for example, the operator may be presented with a user interface (e.g., user interface 432) for viewing captured data (e.g., image data) and identified objects. The operator may select, from the user interface, the particular refuse cart. Using user interface 432 as an example, the operator may select one of multiple refuse carts in order to initiate collection of the particular refuse cart. For example, the user interface may display an image from a camera (e.g., one of the image/object sensors 430) with multiple refuse carts in the image. The refuse carts may be highlighted, for example, without bounding boxes or different colors, brightnesses, number labels, etc. A user may select one of the refuse carts by, for example, touching the image of the refuse cart on a touchscreen, clicking the image of the refuse cart, entering a number label associated with the refuse cart using a keyboard, etc.

At step 504, a location of the identified refuse cart is determined. In some embodiments, the controller may determine the location of the refuse cart based on the location of the refuse vehicle or a component thereof (e.g., the actuator assembly, the lift assembly, the grabber assembly, the grabber arms, etc.), such that the location of the refuse cart is determined relative to the refuse vehicle. In some embodiments, the controller may be configured to determine the location of the detected refuse cart based on sensor data from image/object sensors 430. For example, data from LIDAR, radar, sonic, or optical sensors may be used to determine a location of the refuse cart, and/or may be used to supplement other data (e.g., from a visible light camera). In some examples, image data from a camera may be processed to determine the position of the refuse cart. For example, the distance from a side of the refuse vehicle to the refuse cart may be determined based on the size of the refuse cart in an image captured by the camera, and a lateral position (e.g., forward or rearward of the actuator assembly) of the refuse cart relative to the refuse vehicle may be determined based on the lateral position of the refuse cart in the image captured by the camera.

At step 506, a trajectory is generated for the refuse vehicle based on the determined location of the refuse cart. Simultaneously, at step 508, a trajectory is generated for an actuator assembly of the refuse vehicle. Among other benefits, performing such operations at the same time can improve system efficiency and can provide greater overall positioning accuracy for the refuse vehicle and actuator assembly. In other embodiments, operations 506 and 508 may occur at different times (e.g., sequentially). In still further embodiments, the method 500 includes performing only one of operations 506 and 508. The trajectories for the refuse vehicle and actuator assembly may indicate a path that the corresponding systems follow to reach and engage the refuse cart (e.g., relative to a starting position at which the refuse vehicle is located and/or lift system components of the refuse vehicle are located relative to the body of the refuse vehicle or another portion of the refuse vehicle).

The trajectory of the refuse vehicle, for example, may indicate a path or a set of movements for the refuse vehicle to follow to move next to the refuse cart so that the actuator assembly may move to engage the refuse cart. For example, if the refuse cart is determined in step 504 to be forward of the actuator assembly and too far from the side of the refuse vehicle for collection, the trajectory of the refuse vehicle may be generated to move the refuse vehicle forward and toward the refuse cart (e.g., to the right where the actuator assembly is on the right side of the refuse vehicle). The trajectory of the actuator assembly may indicate a path or a set of movements that the actuator assembly may follow to engage the refuse cart once the refuse vehicle has moved alongside the refuse cart or is otherwise brought into alignment with the refuse cart based on the trajectory of the refuse vehicle. For example, the trajectory of the actuator assembly may include how far to extend a grabber assembly from the side of the refuse vehicle and when to close the actuator arms.

At steps 510 and 512, the refuse vehicle and actuator assembly navigate (i.e., move) to the refuse cart. In autonomous and/or semi-autonomous operations, the refuse vehicle (e.g., refuse vehicle 10) and actuator assembly (e.g., actuator assembly 436) may be controlled or commanded (e.g., by control module 424) to automatically navigate to the refuse cart. For example, the refuse vehicle may automatically move to the refuse cart, and the actuator may automatically move to engage and/or align with the refuse cart, without operator input. In other embodiments, the trajectories generated at steps 506 and 508 may be presented to the operator (e.g., via a user interface) so that the operator may navigate the refuse vehicle and/or the actuator to the refuse cart. As an example, the trajectories may be presented via a user interface, indicating a path and/or movements that the operator should follow to navigate to the refuse cart. The method 500 may further include updating the trajectories in real time to facilitate operator interaction with the refuse vehicle and/or the actuator. Such arrangements can enable improved system efficiency since the refuse vehicle and the actuator may be repositioned at the same time.

In some embodiments, as the refuse vehicle and/or the actuator assembly navigate (i.e., move) towards the refuse cart, image data and/or sensor data may be captured from the various subsystems of the refuse vehicle (e.g., vehicle systems 434) and/or from the actuator assembly (e.g., actuator assembly 436). The captured image and/or sensor data may be transmitted to feedback module 426 in order to improve, modify, and/or otherwise adjust the movements of the refuse vehicle and/or actuator assembly. As described above, feedback module 426 may include an RNN for processing feedback data. As an example, feedback module 426 may interpret feedback data on the movement of the actuator assembly to adjust the trajectory of the actuator assembly as it moves to engage the refuse cart.

At step 514, the refuse cart is engaged by the actuator assembly. The refuse cart may be engaged by moving the actuator assembly in any suitable direction to engage and lift the refuse cart. For example, the actuator assembly may move horizontally, vertically, and or orthogonally to the refuse vehicle in order to engage the refuse cart. Once the actuator assembly has secured the refuse cart (e.g., by closing actuators), the actuator assembly may lift the refuse cart to empty the contents of the refuse cart into a refuse compartment (e.g., refuse compartment 30).

The process 500 may be sufficient for collecting a refuse cart that is unobstructed and properly oriented. However, a process that takes into account the condition of the cart, rather than position alone, may be desirable. In real-world collection scenarios, common conditions that interfere with the automated or semi-automated collection of refuse carts include refuse carts that are close to objects (including other refuse carts or bagged refuse), refuse carts that are not aligned with the grabber assembly, overfilled carts, carts containing hot, burning, or smoking material, and refuse carts with open lids. The process 500 may also be insufficient for accurate collection where a municipality or other refuse collector offers different sizes of refuse carts. Accordingly, it may be desirable to include additional control measures to ensure a higher collection success rate.

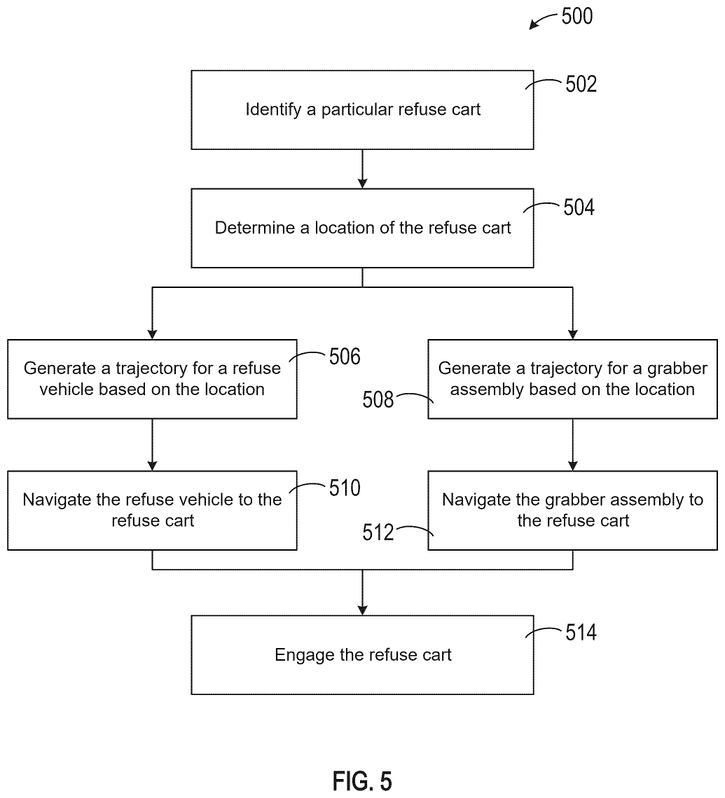

Referring now to FIGS. 6A and 6B, a first refuse vehicle 600 and a second refuse vehicle 601 are shown, respectively, in the process of engaging a respective refuse cart 602, 603. The refuse vehicles 600, 601 may be substantially similar to the refuse vehicle 10. The second refuse cart 603 being engaged by the second refuse vehicle 601 is unobstructed and aligned with the grabber assembly 42. For example, a front face of the second refuse cart 603 is perpendicular to the direction that the grabber assembly 42 extends from the second refuse vehicle 601 when engaging a refuse cart. Accordingly, the process 500 may be suitable for engaging the second refuse cart 603. The first refuse cart 602, however, is positioned close to an obstruction, shown as a third refuse cart 604. The third refuse cart 604 is positioned adjacent to the first refuse cart 602 in the direction of travel of the first refuse vehicle. As shown in FIG. 6B, the grabber assembly 42 of the second refuse vehicle 601 is in a substantially fully opened position, with the actuators 44 positioned a distance D1 apart. However, because the third refuse cart 604 is positioned close to the first refuse cart 602, if the actuators 44 of the grabber assembly 42 of the first refuse vehicle 600 were opened a distance D1, the actuators 44 could contact the third refuse cart 604, which could interfere with the engagement of the grabber assembly 42 with the first refuse cart 602. Additionally, the third refuse cart 604 could be moved out of alignment or knocked over, interfering with the subsequent engagement of the third refuse cart 604.

As shown in FIG. 6A, however, the first refuse vehicle 600 includes one or more image/object sensors 430 (as described with respect to FIG. 4) configured to detect the position of the first refuse cart 602 as well as nearby obstructions. With the first refuse cart 602 and the third refuse cart 604 detected by the sensors, the grabber assembly 42 may be controlled to only partially open (e.g., open less than the grabber assembly 42 of the second refuse vehicle 601. For example, the actuators 44 of the first refuse vehicle 600 may be separated by a distance D2 that is less than the distance D1 that the actuators 44 are separated by when in the process of engaging an unobstructed refuse cart 603. Thus, when the controller 400 detects an obstruction adjacent to the refuse cart 602, the controller 400 may modify the collection routine by adjusting a distance between the actuator arms 44 of the grabber assembly 42 before translating the actuator arms 44 (and in the embodiment shown, the entire grabber assembly 42) towards the refuse cart 602 and engaging the refuse cart 602 with the actuator arms 44. For example, if the controller 400 does not detect an obstruction adjacent to a refuse cart (e.g., the second refuse cart 603), the controller 400 may be configured to translate the actuator arms 44 towards the refuse cart 603 with a first distance (e.g., distance D1) between the actuator arms 44, and when the controller 400 does detect an obstruction adjacent to the refuse cart (e.g., the first refuse cart 602), the controller 400 may configured to translate the actuator arms 44 towards the refuse cart 602 with a second distance (e.g., distance D2) between the actuator arms, the second distance D2 smaller than (e.g., less than) the first distance D1.

In use, the image/object sensors 430 may detect both the first refuse cart 602 and the third refuse cart 604 and send signals to the object detector 420, which may process the signals. In some embodiments, the object detector 420 may determine which of the two refuse carts 602, 604 should be engaged, for example, based on a color or the refuse cart 602, 604 or an identifying marker (e.g., a QR code, a label, etc.). In other embodiments, the UI manager 422 may prompt the operator of the refuse vehicle 600, via the user interface 432, to select which of the refuse carts 602, 604 should be engaged. Upon determining that the first refuse cart 602 should be engaged, the object detector 420 may determine that the third refuse cart 604 is too close to the first refuse cart 602 for the actuators 44 to be positioned the distance D1 apart. The control module 424 may then control the grabber assembly 42 to partially close the grabber assembly 42 such that the actuators 44 are the distance D2 apart. The control module 424 may then control the grabber assembly 42 to engage the first refuse cart 602 without contacting or without substantially moving the third refuse cart 602.

The larger distance D1 between the actuators 44 when engaging an unobstructed refuse cart 603 may allow for more misalignment between the grabber assembly 42 and the first refuse cart 602 than the smaller distance D2. Thus, in some embodiments, when an obstruction such as the third refuse cart 604 is detected, the control module 424 may control the first refuse vehicle 600 to adjust the alignment of the grabber assembly 42 and the first refuse cart 602. For example, the control module 424 may control vehicle systems 434 causing the prime mover of the refuse vehicle 600 to move the entire refuse vehicle 600, or may control an actuator (e.g., of the actuator assembly 436) causing the lateral position of the grabber assembly 42 to be adjusted (e.g., towards the front or back of the refuse vehicle). In other embodiments, the UI manager 422 may instruct the operator of the refuse vehicle 600, via the user interface 432 to operate the refuse vehicle 600 to adjust the alignment. In some embodiments, rather than adjusting the distance D1 between actuators 44, the control module 424 may control the first refuse vehicle 600 such that the grabber assembly 42 is not aligned with the center of the refuse cart 602 and instead offset from the center such that the actuator 44 on the side of the obstruction is closer than the opposite actuator to the refuse cart 602. However, if, for example, there are obstructions on both sides of the refuse cart 602, it may be preferable to reduce the distance between the actuators 44 as discussed above.

As discussed above, the control module 424 may control the grabber assembly 42 such that the distance between the actuators 44 (D1, D2, etc.) is adjusted before the grabber assembly engages a refuse cart. In general, it may be desirable to minimize the distance between the actuators 44 before the grabber assembly 42 engages the refuse cart while still ensuring that the refuse cart is properly engaged, as this may reduce the likelihood that the actuators 44 contact undetected objects.

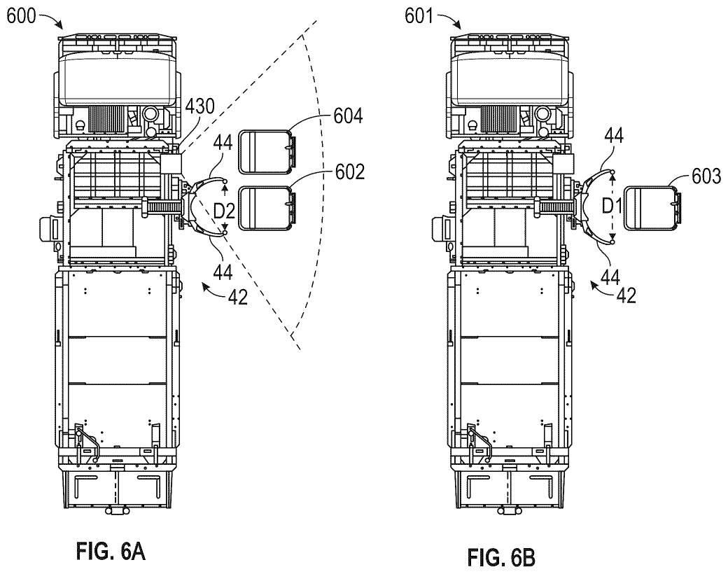

Referring now to FIGS. 7A-7D, several examples of grabber assemblies 42a-42d (e.g., similar to the grabber assembly 42) prior to engaging refuse carts 701-704 are shown. As discussed above, the grabber assemblies 42a-42d may be coupled to a refuse vehicle 10. The first grabber assembly 42a, shown in FIG. 7A, is configured to engage a first refuse cart 701 of a first size that is properly aligned with the grabber assembly 42a. For example, the center of the first refuse cart 701 may be substantially aligned with the center of the first grabber assembly 42a, and the front face 705 of the first refuse cart 701 may be substantially perpendicular to the direction that the first grabber assembly 42a extends from the refuse vehicle 10. The first grabber assembly 42a may be partially closed from a fully open position before the first grabber assembly 42 is moved toward the first refuse cart 701, such that the distance D3 between the actuators 44 of the grabber assembly 42a is less than a maximum distance between the actuators 44. For example, the distance D3 may be larger than (e.g., greater than) a width W1 of the first refuse cart 701 by a predetermined amount (e.g., 1% larger, 5% larger, 10% larger, 15% larger, 20% larger, etc.). The object detector 420 may receive sensor data from the image/object sensors 430 and may determine, based on the sensor data, the width of the refuse cart 701, as well as the alignment. In some embodiments, the image/object sensors 430 may detect an identifying marker (e.g., a QR code, a label, etc.), and the object detector may determine the width of the cart 701 by querying a database and correlating the identifying marker with a stored width. The control module 424 may then control the first grabber assembly 42a to set the distance between the actuators 44 to the distance D3.

A second refuse cart 702, shown in FIG. 7B, may be smaller in size than the first refuse cart 701 and is shown prior to being engaged by the second grabber assembly 42b. The second refuse cart 702 may have a width W2 that may be smaller than the width W1 of the first refuse cart 701. The second refuse cart 702 is shown properly aligned and oriented with the second grabber assembly 42b, with the center of the first refuse cart 701 substantially aligned with the center of the first grabber assembly 42a, and the front face 706 of the second refuse cart 702 oriented substantially perpendicular to the direction that the second grabber assembly 42b extends from the refuse vehicle 10. Because the width W2 is smaller than the width W1, the second grabber assembly 42b may be more closed than the first grabber assembly 42a. For example, a distance D4 between the actuators 44 of the second grabber assembly 42b may be less than the distance D3 between the actuators 44 of the first grabber assembly 42a. As used herein, “alignment” may refer to the distance between the centerline of a grabber assembly and the center of a refuse cart 701-704. As used herein, “orientation” may refer to the angle of the refuse cart 701-704 relative to the direction that the grabber assembly 42 extends from the refuse vehicle 10.

Thus, when the controller 400 detects a first refuse cart (e.g., the first refuse cart 701) having a first width, the controller 400 is configured to translate the actuator arms 44 towards the refuse cart 701 with a first distance (e.g., distance D3) between the actuator arms 44, and when the controller 400 detects a second refuse cart (e.g., the second refuse cart 702) having a second width smaller than the first width, the controller 400 is configured to translate the actuator arms 44 towards the refuse cart 702 with a second distance (e.g., distance D4) between the actuator arms 44, the second distance D4 smaller than the first distance D3.

A third refuse cart 703, shown in FIG. 7C, may be the same size as the first refuse cart 701 and is shown misaligned with the third grabber assembly 42c. Specifically, the third refuse cart 703 is shown centered with the center of the third grabber assembly 42c but is positioned at an angle to the third grabber assembly 42c. For example, a front face of the 707 of the third refuse cart 703 is not substantially perpendicular to the direction that the third grabber assembly 42c extends from the refuse vehicle 10. A distance D5 along an axis perpendicular to the direction that the third grabber assembly 42c extends from the refuse vehicle 10 is thus larger than a width W3 of the third refuse cart 703. Accordingly, when the object detector 420 receives sensor data from the image/object sensors 430 indicating that the third refuse cart 703 is at an angle to the third grabber assembly 42c, the control module 424 may control the third grabber assembly 42c such that the distance D6 between the actuators 44 is larger than the distance D3 between the actuators when a refuse cart of the same size (e.g., the first refuse cart 701) is properly aligned. For example, the distance D6 may be larger than the distance D5 by a predetermined amount (e.g., 1% larger, 5% larger, 10% larger, 15% larger, 20% larger, etc.). The object detector 420 may directly determine the distance D6 based on sensor data from the image/object sensors 430 or may calculate the distance based on the length L1 of the third refuse cart 703, width W3 of the third refuse cart 703, and the angle e of the front face of the 707 of the third refuse cart 703 relative to the direction that the third grabber assembly 42c extends from the refuse vehicle 10. For example, the distance D5 may be equal to W3*sin(180°−θ)+L1*cos(180°−θ). The distance D5 may be considered an “effective width” of the third refuse cart 703 and may be the width of the third refuse cart 703 projected on a plane perpendicular to the direction that the third grabber assembly 42c extends from the refuse vehicle 10. The distance D3 between actuators may thus be controlled to be larger than the effective width by a predetermined amount as discussed above.

Thus, when the controller 400 detects or otherwise determines that the refuse cart (e.g., the third refuse cart 703) is oriented with a front face 706 of the refuse cart 703 that is angled relative to a translation direction of the grabber assembly 42 (e.g., a refuse cart that is not perpendicular to a translation direction of the grabber assembly 42, a refuse cart having sidewalls that are not parallel or perpendicular to a translation direction of the grabber assembly 42), the controller 400 is configured to translate the actuator arms 44 towards the refuse cart 703 with the actuator arms 44 spaced apart by a first distance (e.g., distance D6). When the controller 400 detects or otherwise determines that the refuse cart (e.g., first refuse cart 701) is oriented with the front face 705 of the refuse cart 701 perpendicular to the translation direction of the grabber assembly 42, the controller 400 is configured to translate the actuator arms 44 towards the refuse cart 701 with the actuator arms 44 spaced apart by a second distance (e.g., distance D3) that is smaller than the first distance D6.

A fourth refuse cart 704, shown in FIG. 7D, may be the same size as the first refuse cart 701 and is shown misaligned with the fourth grabber assembly 42d. Specifically, a front face of the 708 of the fourth refuse cart 704 is shown substantially perpendicular to the direction that the fourth grabber assembly 42d extends from the refuse vehicle 10, but the fourth refuse cart 704 is not centered on the center of the fourth grabber assembly 43c. Specifically, the center of the fourth refuse cart 704 is a distance D7 from the center of the fourth grabber assembly 43d measured along an axis perpendicular to the direction that the fourth grabber assembly 42d extends from the refuse vehicle 10. The control module 424 may be configured to control the fourth grabber assembly 42d such that the distance D8 between the actuators 44 is larger than the distance D3 between the actuators when a refuse cart of the same size (e.g., the first refuse cart 701) is properly aligned. For example, the distance D8 may be a distance larger than the width W4 plus two times the distance D7 by a predetermined amount (e.g., 1% larger, 5% larger, 10% larger, 15% larger, 20% larger, etc.).

Thus, when the controller 400 detects that the refuse cart (e.g., the fourth refuse cart 704) is not aligned with a center of the grabber assembly 42, the controller 400 is configured to translate the actuator arms 44 towards the refuse cart 704 with a first distance (e.g., distance D8) between the actuator arms 44, and when the controller 400 detects that the refuse cart (e.g., the first refuse cart 701) is aligned with the center of the grabber assembly 42, the controller 400 is configured to translate the actuator arms 44 towards the refuse cart 701 with a second distance (e.g., distance D3) between the actuator arms 44, the second distance D3 smaller than the first distance D8.

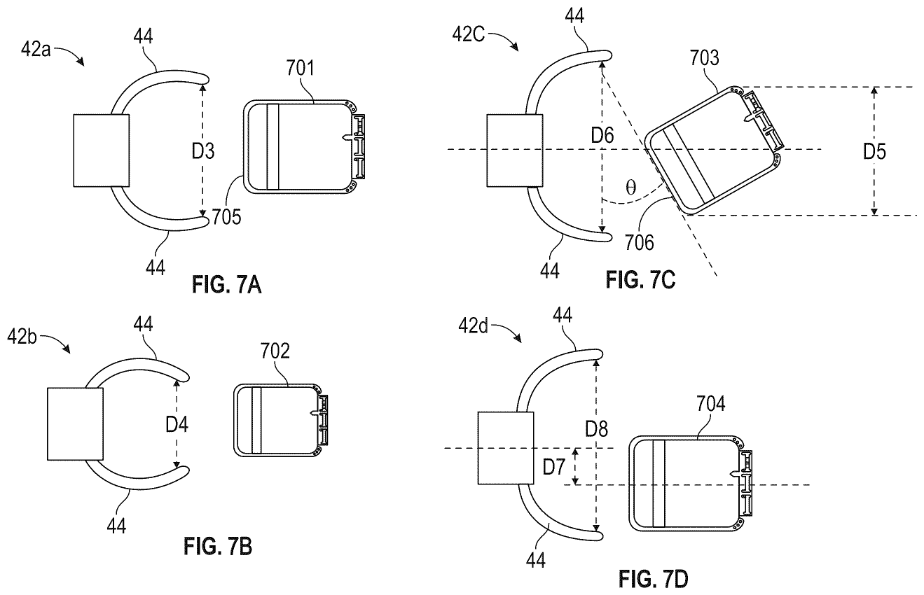

Referring now to FIG. 8, a method 800 of operating a refuse vehicle with an automated or semiautomated cart collection system (e.g., a grabber assembly 43) is shown, according to an exemplary embodiment. At operation 802 of the method 800, a location of a refuse cart is detected, for example, by one or more sensors (e.g., optical sensors, position sensors, cameras). In some embodiments, the location of the refuse cart may be determined based on the location of the refuse vehicle, such that the location of the refuse cart is determined relative to the refuse vehicle 10. For example, in some embodiments, sensor data from image/object sensors 430 may be used to determine the location of the refuse cart. For example, data from LIDAR or radar sensors may be used to determine a location of the refuse cart, and/or may be used to supplement other data (e.g., from a visible light camera). The image/object sensors 430 may detect the location of the refuse cart as the refuse vehicle 10 approaches the refuse cart and/or when the refuse vehicle 10 is positioned adjacent to the refuse cart.

At operation 804 of the method 800, a width of the refuse cart is detected. For example, the width may be determined based on sensor data from one or more sensors (e.g., optical sensors, position sensors, cameras), such as the image/object sensors 430. In some embodiments, an identifying marker (e.g., a QR code, a label, etc.) may be detected by the sensors, and the width over the refuse cart may be determined by correlating the identifying marker with a width stored in a lookup table, e.g., in the memory 406. At operation 806 of the method 800, an orientation of the refuse cart may be detected. For example, the orientation may be determined based on sensor data from one or more sensors (e.g., optical sensors, position sensors, cameras), such as the image/object sensors 430. For example, the sensors may detect an orientation of the refuse cart based on an angle of the refuse cart relative to the refuse vehicle 10 (and thereby an angle of the refuse cart relative to the direction that the grabber assembly 42 extends from the refuse vehicle 10). At operation 808 of the method 800, an alignment of the refuse cart may be determined based on sensor data from one or more sensors (e.g., optical sensors, position sensors, cameras), such as the image/object sensors 430. For example, to determine the alignment, the sensors may detect a distance between a center line of the grabber assembly 42 and a center of the refuse cart.

At operation 810 of the method 800, whether an obstruction is present in the region surrounding the refuse cart and the location of the obstruction relative to the refuse cart are determined. For example, based on sensor data from one or more sensors (e.g., optical sensors, position sensors, cameras), such as the image/object sensors 430, it may be determined whether an obstruction is positioned adjacent the refuse cart in the direction of travel of the refuse vehicle when the grabber assembly 42 is positioned on the side of the vehicle. For example, at operation 810, obstructions may be detected “next to” the refuse cart as opposed to in front of or behind the refuse cart when looking at the refuse cart from the refuse vehicle in position to collect the refuse cart.

At operation 812 of the method 800, a distance between actuators of the grabber assembly may be adjusted based on at least one of the width of the refuse cart, the orientation of the refuse cart, the alignment of the refuse cart to the grabber assembly, or the presence of an obstruction. The control module 424 may actuate the actuators 44 to adjust the distance therebetween. For example, the distance between the actuators of the grabber assembly may be adjusted based on the width of the refuse cart such that the distance between actuators is larger than the width by a predetermined percentage. Thus, when a narrower refuse cart is detected, the distance between actuators may be reduced compared to the distance between actuators when a wider refuse cart is detected. In some embodiments, The distance between actuators may be adjusted based on the orientation of the refuse cart. For example, if the refuse cart is at an angle to the grabber assembly (e.g., the front face of the refuse cart is not perpendicular to the direction that the grabber assembly extends from their refuse vehicle, the front face is oriented at an oblique angle relative to a translation direction of the grabber assembly, etc.), the distance between actuators may be increased compared to the distance between actuators when the refuse cart is not at an angle to the grabber assembly. As discussed above, this may be because the angle of the refuse cart causes the effective width of the refuse cart to be wider than the width of the refuse cart measured across the front face of the refuse cart.

In some embodiments, the distance between actuators may be adjusted based on the alignment of the refuse cart to the grabber assembly. For example, if the center of the refuse cart is not aligned with the center line of the grabber assembly, the distance between actuators may be increased compared to the distance between actuators when the center of the refuse cart is aligned with the center line of the grabber assembly. As discussed above, the distance between the actuators may be increased so that the actuator extends beyond the edge of the refuse cart in the direction that the refuse cart is out of alignment. In some embodiments, the distance between actuators may be reduced based on the presence of an obstruction adjacent the refuse cart such that the actuators do not contact the obstruction. In operation 812, any or all of these factors, (the width, orientation, and alignment of the refuse cart and the presence of an obstruction) may be taken into account to adjust the distance between the actuators of the grabber assembly.

At operation 814 of the method 800, the actuators may be translated toward the refuse can. Operation 812 may occur before operation 814 such that the distance between the actuators is set before the actuators are translated towards the refuse cart. In some embodiments, translating the actuators toward the refuse cart may include translating the entire grabber assembly toward the refuse cart. For example, the control module 424 may cause a linear actuator or other actuator to translate the grabber assembly 42 towards the refuse cart. At operation 816 of the method 800, the actuators of the grabber assembly may be actuated to engage the refuse cart. For example, the control module 424 may send a signal to the grabber assembly 42 causing the actuators 44 to actuate and engage the refuse cart. The method 800 may further include lifting the refuse cart and emptying the contents of the refuse cart into a hopper volume of the refuse vehicle.

In some embodiments, operation 812 may include providing information to a user via a user interface and receiving a user input. For example, the operator of the refuse vehicle may be prompted, via the user interface 432, to confirm the distance between the actuators 44 or to make manual adjustments before operation 814 is executed and the refuse cart is engaged. In some embodiments, upon detecting the obstruction in operation 810 or upon detecting that the misorientation or misalignment exceeds a threshold or limit, the operator may be instructed or requested to execute operations 812-816 manually (e.g., via the user interface 432).

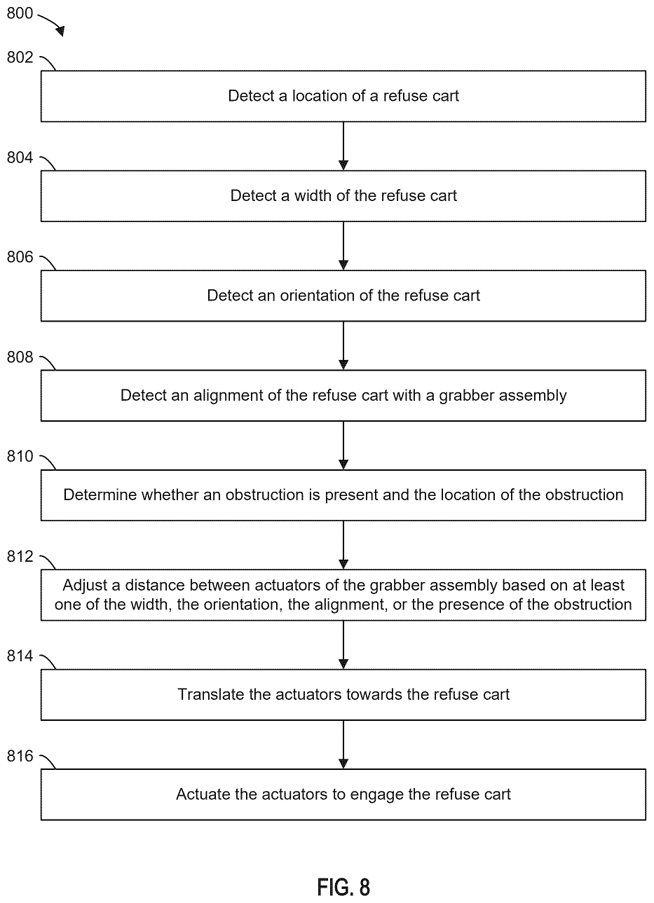

Referring now to FIG. 9A and 9B, two refuse carts 901, 902 are shown, respectively, with refuse bags 904 partially obstructing the second refuse cart 902. In some embodiments, the grabber assembly 42 may be controlled to adjust the grab height of the actuators 44 when the normal grab height is obstructed. The first refuse cart 901 of FIG. 9A is shown with the ideal grab region 906 shown as a rectangular box. The ideal grab region 906 is located between a height H1 measured from the bottom of the first refuse cart 901 and a height H2 measured from the bottom of the first refuse cart 901. The ideal grab region 906 may be determined based on the geometry of the refuse cart 901 as well as the geometry of the refuse vehicle 10. For example, engaging the refuse cart 901 in the ideal grab region 906 may result in the highest rate of successful refuse cart engagement by the grabber assembly 42 and the highest likelihood that refuse in the refuse cart 901 is successfully collected and emptied into the hopper volume of the refuse vehicle 10 (e.g., as opposed to falling out of the refuse cart 901 as the refuse cart 901 is lifted or being emptied outside of the hopper volume). Attempting to engage the refuse cart 901 outside the ideal grab region 906 may result in lower success rates.

As discussed above, the second refuse cart 902, shown in FIG. 9B, is partially obstructed by the refuse bags 904. In particular, a lower portion of the second refuse cart 902 is obstructed by the refuse bags 904. In some embodiments, the lower portion of the second refuse cart 902 may be obstructed by other objects (e.g., fallen refuse carts, lawn waste, etc.). The lower portion of the refuse cart 902 may be obstructed in front of, next to, or behind the refuse cart 902. As shown in FIG. 9B, the refuse bags 904 obstruct the ideal grab region 906 of the second refuse cart. When collecting the refuse in the second refuse cart 902, the refuse bags 904 may be detected, for example, by the image/object sensors 430 and the object detector 420. Based on the detected obstruction, the control module 424 may adjust the grab height of the grabber assembly 42 to a position outside the ideal grab region 906. For example, the grabber assembly 42 may engage the second refuse cart 902 in an alternate grab region 908 above the ideal grab region 906 and the refuse bags 904. The alternate grab region 908 may be located between a height H3 measured from the bottom of the second refuse cart 902 and a height H4 measured from the bottom of the second refuse cart 902. The alternate grab region 908 may overlap the ideal grab region 906 or may be entirely above the ideal grab region 906. In some embodiments, the alternate grab region 908 may be a region with a relatively high engagement and collection success rate compared to other regions, though lower than the ideal grab region 906. In some embodiments, the alternate grab region 908 may be as close as possible to the ideal grab region 906 without being obstructed by the refuse bags 904 (or another obstruction).

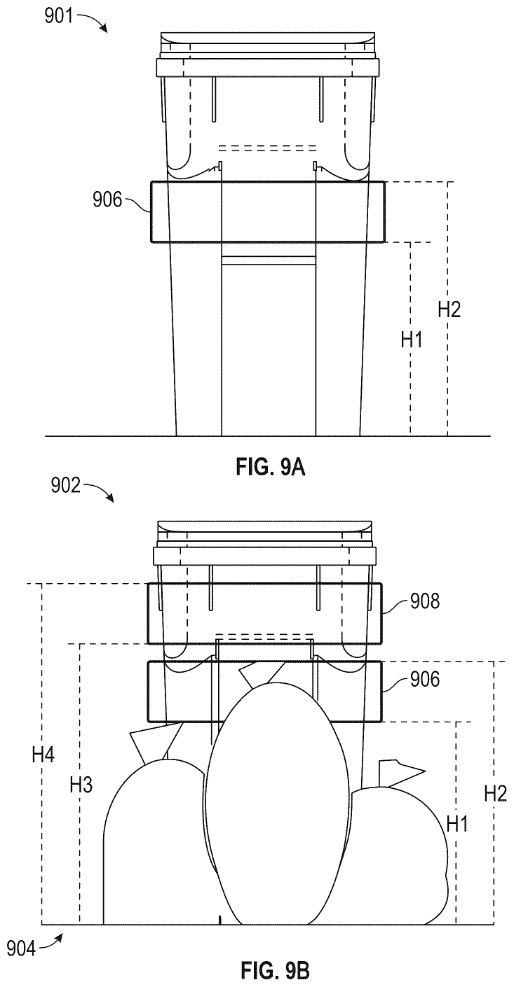

Referring now to FIG. 10, two refuse carts 1001, 1002 are shown, with the lid 1003 of the second refuse cart 1002 open. In some embodiments, the grabber assembly 42 may be controlled to adjust the grab height of the actuators 44 when the lid is open, such that the actuators 44 do not contact and potentially damage the lid 1003. The first refuse cart 1001 is shown with the ideal grab region 906 shown between a height H1 measured from the bottom of the first refuse cart 1001 and a height H2 measured from the bottom of the first refuse cart 1001.

As discussed above, the lid 1003 of the second refuse cart 1002 is open and hanging down with its distal end 1004 at a minimum height H5 measured from the bottom of the second refuse cart 1002 that is lower than the height H2 (and the height H1). Because it may be desirable to avoid contacting the lid 1003 with the actuators 44 of the grabber assembly 42, the lid 1003 may be considered an obstruction of an upper portion of the refuse cart 1002 and of the ideal grab region 906. In some embodiments, other obstructions (e.g., overhanging tree branches, leaning refuse carts, etc.) may obstruct the upper portion of the refuse cart 1002. When collecting the refuse in the second refuse cart 1002, the open lid 1003 may be detected, for example, by the image/object sensors 430 and the object detector 420. Based on the detected open lid 1003, the control module 424 may adjust the grab height of the grabber assembly 42 to a position outside the ideal grab region 906. For example, the grabber assembly 42 may engage the second refuse cart 1002 in an alternate grab region 1008 below the ideal grab region 906 and the distal end 1004 end of the lid 1003. The alternate grab region 1008 may be located between a height H6 measured from the bottom of the second refuse cart 902 and a height H7 measured from the bottom of the second refuse cart 902. The alternate grab region 1008 may overlap the ideal grab region 906 or may be entirely below the ideal grab region 906. In some embodiments, the alternate grab region 1008 may be a region with a relatively high engagement and collection success rate compared to other regions, though lower than the ideal grab region 906. In some embodiments, the alternate grab region 1008 may be as close as possible to the ideal grab region 906 without being obstructed by the lid 1003 (or another obstruction).

Thus, when the controller 400 detects an obstruction proximate an upper portion or a lower portion of a refuse cart, the controller 400 may modify the collection routine by adjusting a height of the actuator arms 44 (and in the embodiment shown, the entire grabber assembly 42) before translating the actuator arms 44 (and in the embodiment shown, the entire grabber assembly 42) towards the refuse cart and engaging the refuse cart with the actuator arms 44. For example, if the controller 400 does not detect an obstruction proximate an upper portion of a refuse cart (e.g., refuse cart 1001), the controller 400 may be configured to translate the actuator arms 44 towards the refuse cart 1001 at a first height (e.g., between heights H1 and H2), and when the controller 400 does detect an obstruction proximate an upper portion of the refuse cart (e.g., refuse cart 1002), including an open lid or another obstruction, the controller 400 may configured to translate the actuator arms 44 towards the refuse cart 1002 at a second height (e.g., between heights H6 and H7), the second height lower than the first height. If the controller 400 does not detect an obstruction proximate a lower portion of a refuse cart (e.g., refuse cart 901), the controller 400 may be configured to translate the actuator arms 44 towards the refuse cart 1001 at a first height (e.g., between heights H1 and H2), and when the controller 400 does detect an obstruction proximate a lower portion of the refuse cart (e.g., refuse cart 902), the controller 400 may configured to translate the actuator arms 44 towards the refuse cart 902 at a third height (e.g., between heights H3 and H4), the third height higher than the first height.

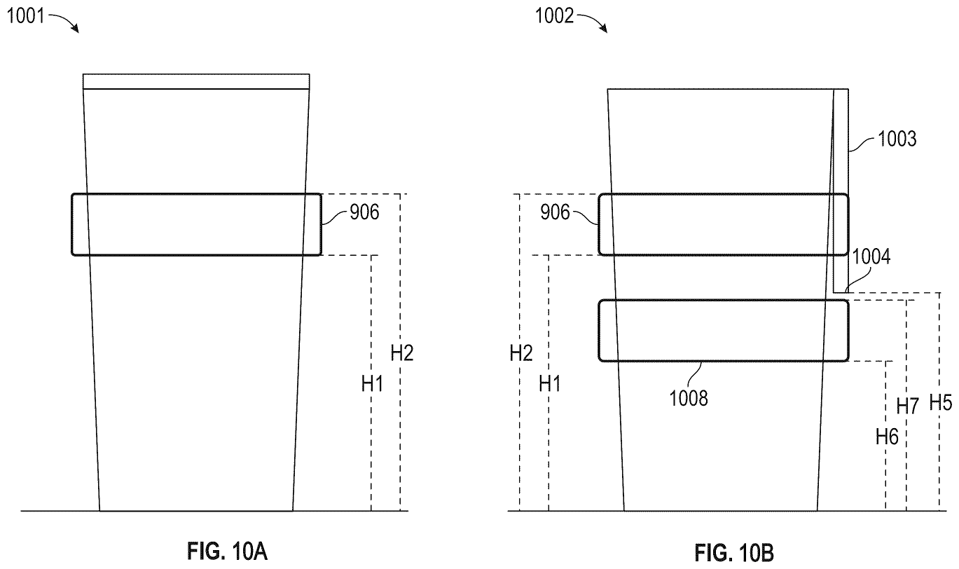

Referring now to FIG. 11, a method 1100 of operating a refuse vehicle with an automated or semiautomated cart collection system (e.g., a grabber assembly 43) is shown, according to an exemplary embodiment. At operation 1102 of the method 1100, a location of a refuse cart is detected, for example, by one or more sensors (e.g., optical sensors, position sensors, cameras). In some embodiments, the location of the refuse cart may be determined based on the location of the refuse vehicle, such that the location of the refuse cart is determined relative to the refuse vehicle 10. For example, in some embodiments, sensor data from image/object sensors 430 may be used to determine the location of the refuse cart. For example, data from LIDAR or radar sensors may be used to determine a location of the refuse cart, and/or may be used to supplement other data (e.g., from a visible light camera). The image/object sensors 430 may detect the location of the refuse cart as the refuse vehicle 10 approaches the refuse cart and/or when the refuse vehicle 10 is positioned adjacent to the refuse cart.

At operation 1104 of the method 1100, whether an obstruction is present in the region surrounding the refuse cart and the location of the obstruction relative to the refuse cart are determined. For example, based on sensor data from one or more sensors (e.g., optical sensors, position sensors, cameras), such as the image/object sensors 430, it may be determined that an obstruction is positioned adjacent a lower portion of the refuse cart or an upper portion of the refuse cart but does not obstruct the entire refuse cart. For example, at operation 1104, obstructions may be detected next to, in front of, or behind the refuse cart but may not fully obstruct the refuse cart such that the actuators cannot engage the refuse cart without contacting the obstruction.

At operation 1106 of the method 1100, a height of actuators of the grabber assembly may be adjusted based on the location of the obstruction. The control module 424 may control an actuator or motor causing the height of the actuators 44 to be adjusted. For example, the height of actuators of the grabber assembly may be adjusted to be positioned above or below the obstruction. The height of the actuators may be adjusted to a height outside of an ideal grab region where the likelihood of successful engagement by the actuators and collection by the grabber assembly is maximized. While the likelihood of successful engagement and collection is reduced, the likelihood of successful engagement and collection may still be high enough to justify attempting the collection where the alternatives may be contacting the obstruction, manual intervention by an operator, or not collecting the refuse in the refuse cart at all.

At operation 1108 of the method 1100, the actuators may be translated toward the refuse can. Operation 1106 may occur before operation 1108 such that the distance between the actuators is set before the actuators are translated towards the refuse cart. In some embodiments, translating the actuators towards the refuse cart may include translating the entire grabber assembly toward the refuse cart. For example, the control module 424 may cause a linear actuator or other actuator to translate the grabber assembly 42 towards the refuse cart. At operation 1110 of the method 1100, the actuators of the grabber assembly may be actuated to engage the refuse cart. For example, the control module 424 may send a signal to the grabber assembly 42 causing the actuators 44 to actuate and engage the refuse cart. The method 1100 may further include lifting the refuse cart and emptying the contents of the refuse cart into a hopper volume of the refuse vehicle.

In some embodiments, operation 1106 may include providing information to a user via a user interface and receiving a user input. For example, the operator of the refuse vehicle 10 may be prompted, via the user interface 432, to confirm the height of the actuators 44 or to make manual adjustments before operation 1108 is executed and the refuse cart is engaged. In some embodiments, upon detecting the obstruction in operation 1104, the operator may be instructed or requested to execute operations 1106-1110 manually (e.g., via the user interface 432).

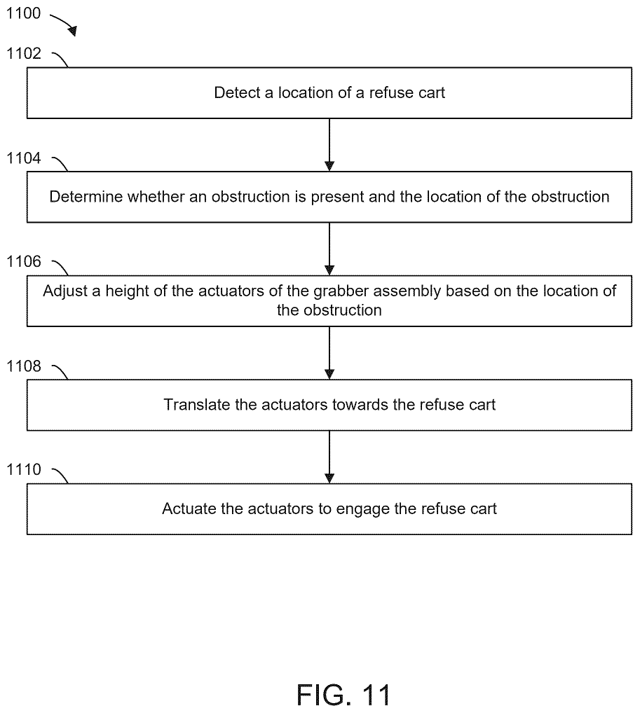

Referring now to FIGS. 12A and 12B, two refuse carts 1201, 1202 are shown, respectively, being engaged by one of a first grabber assembly 42e and a second grabber assembly 42f (e.g., similar to the grabber assembly 42), according to some embodiments. As shown in FIG. 12B, a third refuse cart 1203 is positioned behind the second refuse cart (i.e., the second refuse cart 1202 is between the third refuse cart 1203 and the grabber assembly 42f. In some embodiments, the grabber assembly 42 may be controlled to adjust the translation distance of the actuators 44 away from the refuse vehicle 10 and toward the refuse cart 1202 based on the presence of an obstruction (e.g., the third refuse cart 1203) behind the refuse cart 1202. For example, the first refuse cart 1201 is shown in the process of being engaged by the first grabber assembly 42e. Because there is no obstruction behind the first refuse cart 1201, the grabber assembly 42e maybe extended from the body of the refuse vehicle 10 such that the actuators 44 extend beyond the back side 1204 of the first refuse cart 1201 by a distance D9. Extending the actuators 44 extend beyond the back side 1204 of the first refuse cart 1201 by a distance D9 may maximize the likelihood of successful engagement with the refuse cart 1201.

However, because the third refuse cart 1203 is positioned behind the second refuse cart 1202, extending the actuators 44 beyond the back side 1205 of the second refuse cart 1201 by the distance D9 may cause the actuators to contact the third refuse cart 1203. Thus, the third refuse cart 1203 may be considered an obstruction to the engagement of the second refuse cart 1202 despite being positioned behind the second refuse cart 1202. When an obstruction (e.g., the third refuse cart 1203) is positioned behind the refuse cart 1202 to be engaged by the grabber assembly 42f, the grabber assembly 42f may be controlled to reduce the distance that the actuators 44 translate away from the refuse vehicle 10 and towards the refuse cart 1202. For example, as shown in FIG. 12B, the actuators 44 are translated such that a distance D10 from the back side 1205 of the second refuse cart 1202 to the ends of the actuators is less than the distance D9. In some embodiments, translating the actuators 44 towards the refuse cart 1202 may include translating the entire grabber assembly 42f towards the refuse cart 1202. For example, the control module 424 may cause a linear actuator or other actuator to translate the grabber assembly 42f towards the refuse cart 1202.

Thus, when the controller 400 detects an obstruction behind a refuse cart, the controller 400 may modify the collection routine by adjusting a distance that the actuator arms (and in the embodiment shown, the entire grabber assembly 42) are translated by the lateral actuator 48 towards the refuse cart before the refuse cart is engaged with the actuator arms 44. For example, if the controller 400 does not detect an obstruction behind a refuse cart (e.g., refuse cart 1201), the controller 400 may be configured to translate the actuator arms 44 towards the refuse cart 1201 a first distance, and when the controller 400 does detect an obstruction behind the refuse cart (e.g., refuse cart 1201), the controller 400 may configured to translate the actuator arms 44 towards the refuse cart 1002 a second distance, the second distance smaller than the first distance.

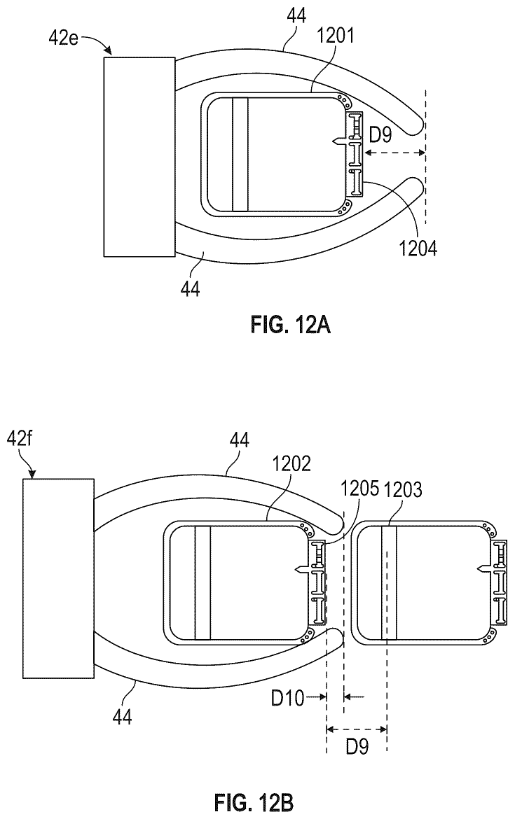

Referring now to FIG. 13, a method 1300 of operating a refuse vehicle with an automated or semiautomated cart collection system (e.g., a grabber assembly 43) is shown, according to an exemplary embodiment. At operation 1302 of the method 1300, a location of a refuse cart is detected, for example, by one or more sensors (e.g., optical sensors, position sensors, cameras). In some embodiments, the location of the refuse cart may be determined based on the location of the refuse vehicle, such that the location of the refuse cart is determined relative to the refuse vehicle 10. For example, in some embodiments, sensor data from image/object sensors 430 may be used to determine the location of the refuse cart. For example, data from LIDAR or radar sensors may be used to determine a location of the refuse cart, and/or may be used to supplement other data (e.g., from a visible light camera). The image/object sensors 430 may detect the location of the refuse cart as the refuse vehicle 10 approaches the refuse cart and/or when the refuse vehicle 10 is positioned adjacent to the refuse cart.

At operation 1304 of the method 1300, whether an obstruction is present in the region surrounding the refuse cart and the location of the obstruction relative to the refuse cart are determined. For example, based on sensor data from one or more sensors (e.g., optical sensors, position sensors, cameras), such as the image/object sensors 430, it may be determined that an obstruction is positioned behind the refuse cart (e.g., with the refuse cart between the refuse vehicle and the obstruction).

At operation 1306 of the method 1300, a translation distance of the actuators of the grabber assembly is determined based on the location of the obstruction. For example, the translation distance may be determined such that, when actuated, the obstruction is a larger distance away than the ends of the actuators from the refuse vehicle. Thus, the actuators will not contact the obstruction when actuated. At operation 1308 of the method 1300, the actuators may be translated toward the refuse can. Operation 1106 may occur before operation 1108 such that the distance between the actuators is set before the actuators are translated towards the refuse cart. In some embodiments, translating the actuators toward the refuse cart may include translating the entire grabber assembly toward the refuse cart. For example, the control module 424 may cause a linear actuator or other actuator to translate the grabber assembly 42 towards the refuse cart. At operation 1310 of the method 1300, the actuators of the grabber assembly may be actuated to engage the refuse cart. For example, the control module 424 may send a signal to the grabber assembly 42 causing the actuators 44 to actuate and engage the refuse cart. The method 1300 may further include lifting the refuse cart and emptying the contents of the refuse cart into a hopper volume of the refuse vehicle.

In some embodiments, operation 1306 may include providing information to a user via a user interface and receiving a user input. For example, the operator of the refuse vehicle 10 may be prompted, via the user interface 432, to confirm the translation distance of the actuators 44 or to make manual adjustments before operation 1308 is executed and the refuse cart is engaged. In some embodiments, upon detecting the obstruction in operation 1304, the operator may be instructed or requested to execute operations 1306-1310 manually (e.g., via the user interface 432). In some embodiments, the method 1300 may be applied to refuse vehicles 10 using, for example, forks or other implements to engage a refuse container (e.g., other than a grabber assembly). For example, upon detecting an obstruction behind a fork-loaded refuse container, the translation distance of forks of the refuse vehicle away from the body of the refuse vehicle may be reduced. Alternatively, if the forks do not translate, the minimum distance between the refuse vehicle and the refuse container may be increased (e.g., using the prime mover and wheels of the refuse vehicle) such that the refuse vehicle is farther away from the refuse container when the refuse container is lifted and the forks do not extend as far beyond the back side of the refuse container.

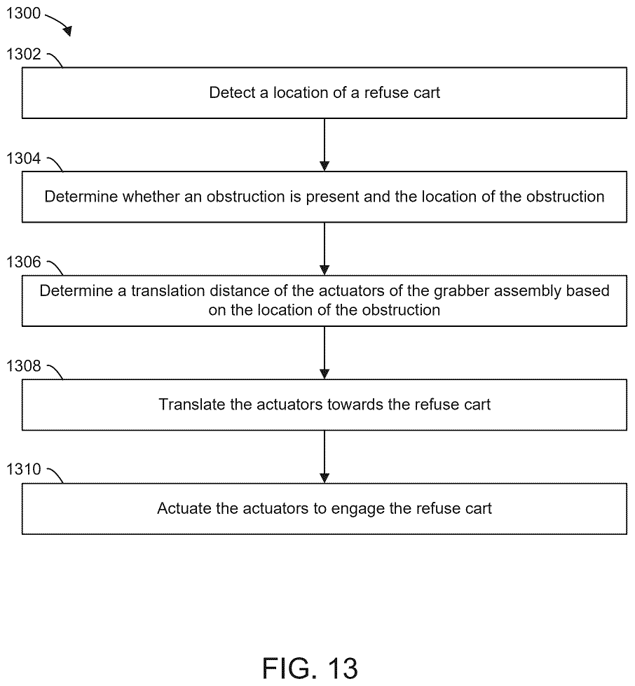

Referring now to FIG. 14, an overfilled refuse cart 1401 is shown. “Overfilled” may refer to a refuse cart 1401 with refuse 1402 extending above the top of the refuse cart 1401, for example, such that the lid can only partially close (e.g., resting on the refuse 1402) or cannot close at all. The refuse vehicle 10 may detect the overfilled refuse cart 1401 (e.g., using the image/object sensors 430 and the object detector 420) and may control the grabber assembly 42 to engage the overfilled refuse cart 1401 and lift the overfilled refuse cart 1401 more slowly than a refuse cart that is not overfilled, in order to reduce the likelihood that the refuse 1402 falls out of the overfilled refuse cart 1401 before reaching the hopper volume of the refuse vehicle 10. In some embodiments, for example, if the refuse cart 1401 is overfilled beyond a threshold fill level, the grabber assembly 42 may be instructed not to engage the refuse cart 1401.

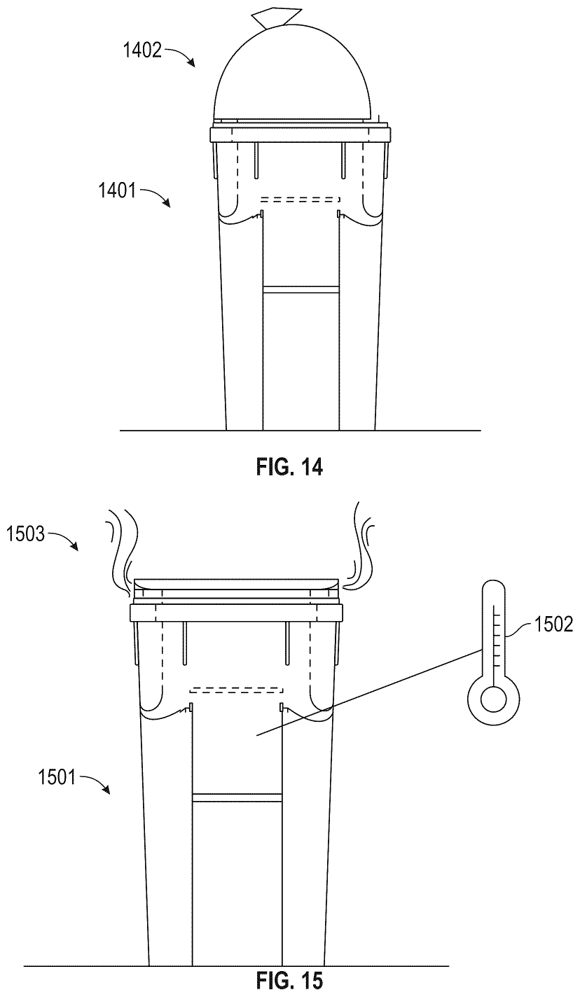

Referring now to FIG. 15, a refuse cart 1501 is shown experiencing a thermal event 1502. “Thermal event” may refer to an item in the refuse cart 1501 being above a threshold temperature, burning, or smoking. The refuse vehicle 10 may detect the thermal event (e.g., using the image/object sensors 430 and the object detector 420) and may instruct the grabber assembly 42 not to engage the overfilled refuse cart 1401, so that the item in the refuse cart is moved to the hopper volume where it may cause a fire. For example, the image/object sensors 430 may further include thermal (e.g., infrared) sensors, smoke sensors, thermometers, or other sensors configured to detect temperature or smoke 1503.

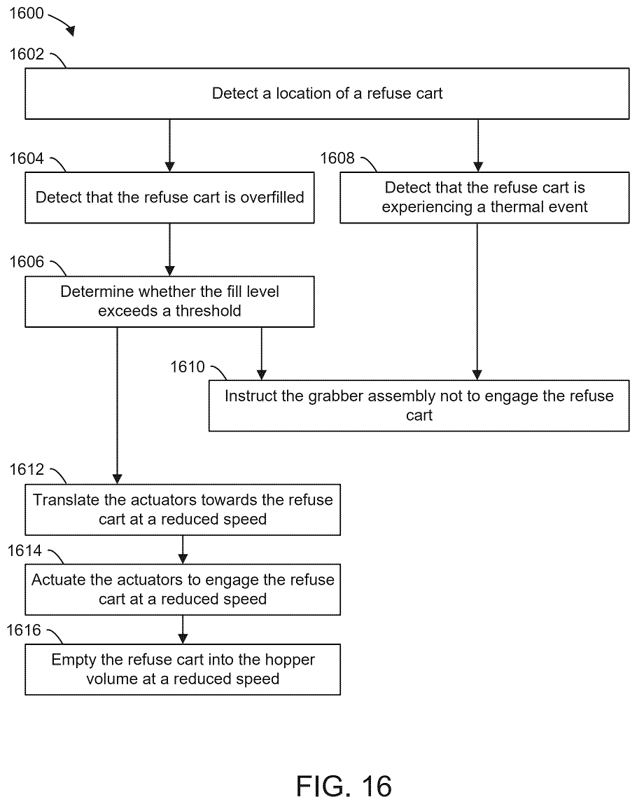

Referring now to FIG. 16, a method 1600 of operating a refuse vehicle with an automated or semiautomated cart collection system (e.g., a grabber assembly 43) is shown, according to an exemplary embodiment. At operation 1602 of the method 1600, a location of a refuse cart is detected, for example, by one or more sensors (e.g., optical sensors, position sensors, cameras). In some embodiments, the location of the refuse cart may be determined based on the location of the refuse vehicle, such that the location of the refuse cart is determined relative to the refuse vehicle 10. For example, in some embodiments, sensor data from image/object sensors 430 may be used to determine the location of the refuse cart. For example, data from LIDAR or radar sensors may be used to determine a location of the refuse cart, and/or may be used to supplement other data (e.g., from a visible light camera). The image/object sensors 430 may detect the location of the refuse cart as the refuse vehicle 10 approaches the refuse cart and/or when the refuse vehicle 10 is positioned adjacent to the refuse cart.

At operation 1604 of the method 1600, it may be detected that the refuse cart is overfilled, and at operation 1606, whether the fill level exceeds a threshold fill level may be determined. If the fill level exceeds the threshold fill level, the method may proceed to operation 1610, in which the grabber assembly is instructed not to engage the refuse cart, and the refuse in the refuse cart is not collected. At operation 1608 of the method 1600, a thermal event is detected. As discussed above, a “thermal event” may refer to an item in the refuse cart being above a threshold temperature, burning, or smoking, which may be detected with the use of infrared sensors, optical sensors, thermometers, or other thermal sensors or smoke detectors. Upon detecting the thermal event at operation 1608, the method may proceed to operation 1610, in which the grabber assembly is instructed not to engage the refuse cart, and the refuse in the refuse cart is not collected.

If at operation 1604 it is determined that the refuse cart is overfilled but at operation 1606 it is determined that the fill level does not exceed a threshold fill level, the method may proceed to operation 1610. At operation 1610 of the method 1600, the actuators of the grabber assembly may be translated toward the refuse cart at a reduced speed relative to the speed the actuators are normally translated when a refuse cart is not overfilled. This may reduce the likelihood that the actuators contact the refuse cart with sufficient speed to knock refuse out of the refuse cart. At operation 1612 of the method 1600, the actuators of the grabber assembly may be actuated to engage the refuse cart at a reduced speed relative to the speed the actuators are normally actuated when a refuse cart is not overfilled. This may reduce the likelihood that the actuators contact the refuse cart with sufficient speed to knock refuse out of the refuse cart. At operation 1614 of the method 1600, the actuators of the grabber assembly may be actuated to engage the refuse cart at a reduced speed relative to the speed the actuators are normally actuated when a refuse cart is not overfilled. This may reduce the likelihood that the actuators contact the refuse cart with sufficient speed to knock refuse out of the refuse cart. At operation 1616 of the method 1600, the grabber assembly may lift the refuse cart and empty the refuse cart into the hopper volume at a reduced speed relative to the speed a refuse cart is lifted and emptied when the refuse cart is not overfilled. This may reduce the likelihood that refuse falls out of the refuse cart.

In some embodiments, the method 1600 may include providing information to a user via a user interface and receiving a user input. For example, the operator of the refuse vehicle 10 may be provided, via the user interface 432, with the option to override the instruction not to engage the refuse cart in operation 1610. In some embodiments, upon detecting the overfilled refuse cart in operation 1604, the operator may be instructed or requested to execute operations 1612-1616 manually (e.g., via the user interface 432).

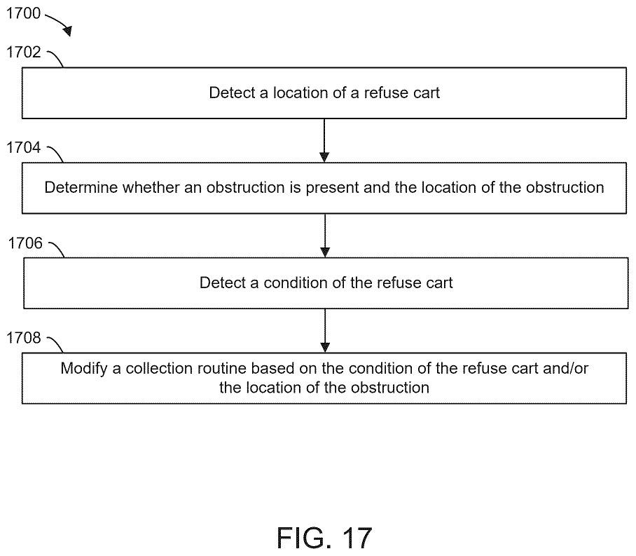

Referring now to FIG. 17, a method 1700 of operating a refuse vehicle with an automated or semiautomated cart collection system (e.g., a grabber assembly 43) is shown, according to an exemplary embodiment. At operation 1702 of the method 1700, a location of a refuse cart is detected, for example, by one or more sensors (e.g., optical sensors, position sensors, cameras). In some embodiments, the location of the refuse cart may be determined based on the location of the refuse vehicle, such that the location of the refuse cart is determined relative to the refuse vehicle 10. For example, in some embodiments, sensor data from image/object sensors 430 may be used to determine the location of the refuse cart. For example, data from LIDAR or radar sensors may be used to determine a location of the refuse cart, and/or may be used to supplement other data (e.g., from a visible light camera). The image/object sensors 430 may detect the location of the refuse cart as the refuse vehicle 10 approaches the refuse cart and/or when the refuse vehicle 10 is positioned adjacent to the refuse cart.

At operation 1704 of the method 1700, whether an obstruction is present in the region surrounding the refuse cart and the location of the obstruction relative to the refuse cart are determined. In some embodiments, based on sensor data from one or more sensors (e.g., optical sensors, position sensors, cameras), such as the image/object sensors 430, it may be determined that an obstruction is positioned in front of, behind, or next to the refuse cart. In some embodiments, based on sensor data from one or more sensors (e.g., optical sensors, position sensors, cameras), such as the image/object sensors 430, it may be determined that an obstruction is positioned adjacent a lower portion of the refuse cart or an upper portion of the refuse cart but does not obstruct the entire refuse cart.

At operation 1706 of the method 1700, a condition of the refuse cart may be determined. In some embodiments, the “condition” of the cart may refer to the size or width of the refuse cart, the orientation of the cart relative to the refuse vehicle, the alignment of the refuse cart with the grabber assembly, the fill level of the refuse cart, the position of the lid (e.g., open, closed, partially open, etc.), and/or whether the refuse cart is experiencing a thermal event.

At operation 1708, a collection routine is modified for collecting the refuse cart based on the presence and location of the obstruction and/or the condition of the refuse cart. In some embodiments, operation 1708 includes modifying the collection routine associated with operation of the actuator arms (e.g., modifying steps performed by the actuator arms during a refuse collection cycle, etc.) based on the location of the obstruction and/or the condition of the refuse cart. For example, as discussed above, modifying the collection routine may include adjusting the height of a grabber assembly based on the presence of an obstruction or the position of the lid. In some embodiments, modifying the collection routine may include adjusting the distance between the actuators of the grabber assembly based on the presence of an obstruction or the size, orientation, and/or alignment of the refuse cart. In some embodiments, modifying the collection routine may include adjusting the speed of the collection based on the fill level of the refuse cart. In some embodiments, modifying the collection routine may include adjusting the translation distance of the actuators toward the refuse cart based on the presence of an obstruction behind the refuse cart. In some embodiments, collection of the refuse cart may be stopped or may require operator intervention to continue, for example, if a thermal event is detected in the refuse cart.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining may be stationary (e.g., permanent) or movable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. A system for detecting and engaging a refuse cart, the system comprising:
a sensor coupled to a refuse vehicle and configured to generate sensor data indicative of objects on one or more sides of the refuse vehicle;
a grabber assembly coupled to the refuse vehicle, the grabber assembly comprising actuator arms that are configured to engage the refuse cart; and
a controller communicably coupled to the sensor and the grabber assembly, the controller configured to:
detect a location of a refuse cart based on the sensor data;
detect a location of an obstruction in a vicinity of the refuse cart based on the sensor data; and
modify a collection routine associated with operation of the actuator arms based on the location of the refuse cart and the location of the obstruction.

2. The system of claim 1, wherein modifying the collection routine comprises adjusting a distance between the actuator arms of the grabber assembly before translating the actuator arms towards the refuse cart and engaging the refuse cart with the actuator arms.

3. The system of claim 2, wherein when the controller does not detect the obstruction adjacent to the refuse cart, the controller is configured to translate the actuator arms towards the refuse cart with a first distance between the actuator arms, and when the controller detects the obstruction adjacent to the refuse cart, the controller is configured to translate the actuator arms towards the refuse cart with a second distance between the actuator arms that is smaller than the first distance.

4. The system of claim 1, wherein the obstruction is proximate an upper portion or a lower portion of the refuse cart, and wherein modifying the collection routine comprises adjusting a height of the actuator arms of the grabber assembly before translating the actuator arms towards the refuse cart and engaging the refuse cart with the actuator arms.

5. The system of claim 4, wherein when the controller does not detect the obstruction proximate the upper portion of the refuse cart, the controller is configured to translate the actuator arms towards the refuse cart at a first height, and when the controller detects the obstruction proximate the upper portion of the refuse cart, the controller is configured to translate the actuator arms towards the refuse cart at a second height that is less than the first height.

6. The system of claim 4, wherein when the controller does not detect the obstruction proximate the lower portion of the refuse cart, the controller is configured to translate the actuator arms towards the refuse cart at a first height, and when the controller detects the obstruction proximate the lower portion of the refuse cart, the controller is configured to translate the actuator arms towards the refuse cart at a third height that is greater than the first height.

7. The system of claim 1, wherein modifying the collection routine comprises adjusting a distance that the actuator arms are translated towards the refuse cart before the refuse cart is engaged with the actuator arms.

8. The system of claim 7, wherein when the controller does not detect the obstruction behind the refuse cart, the controller is configured to translate the actuator arms of the grabber assembly towards the refuse cart by a first distance, and when the controller detects the obstruction adjacent to the refuse cart, the controller is configured to translate the actuator arms towards the refuse cart by a second distance that is less than the first distance.

9. A system for detecting and engaging a refuse cart, the system comprising:
a sensor coupled to a refuse vehicle and configured to generate sensor data indicative of objects on one or more sides of the refuse vehicle;
a grabber assembly coupled to the refuse vehicle, the grabber assembly comprising actuator arms that are configured engage the refuse cart; and
a controller communicably coupled to the sensor and the grabber assembly, the controller configured to:
detect a location of a refuse cart based on the sensor data;
determine a condition of the refuse cart based on the sensor data; and
modify a collection routine associated with operation of the actuator arms based on the location of the refuse cart and the condition of the refuse cart.

10. The system of claim 9, wherein the condition of the refuse cart comprises at least one of a width of the refuse cart, an alignment between the refuse cart and the grabber assembly, or an orientation of the refuse cart, and wherein modifying the collection routine comprises adjusting a distance between the actuator arms of the grabber assembly before translating the actuator arms towards the refuse cart and engaging the refuse cart with the actuator arms.

11. The system of claim 10, wherein when the controller detects a first refuse cart having a first width, the controller is configured to translate the actuator arms towards the refuse cart with a first distance between the actuator arms, and when the controller detects a second refuse cart having a second width less than the first width, the controller is configured to translate the actuator arms towards the refuse cart with a second distance between the actuator arms, the second distance less than the first distance.

12. The system of claim 10, wherein when the controller detects that a front face of the refuse cart is oriented at an oblique angle relative to a translation direction of the grabber assembly, the controller is configured to translate the actuator arms towards the refuse cart with a first distance between the actuator arms, and when the controller detects that the front face of the refuse cart is oriented perpendicular to the translation direction of the grabber assembly, the controller is configured to translate the actuator arms towards the refuse cart with a second distance between the actuator arms that is less than the first distance.

13. The system of claim 10, wherein when the controller detects that the refuse cart is unaligned with a center of the grabber assembly, the controller is configured to translate the actuator arms towards the refuse cart with a first distance between the actuator arms, and when the controller detects that the refuse cart is aligned with the center of the grabber assembly, the controller is configured to translate the actuator arms towards the refuse cart with a second distance between the actuator arms that is less than the first distance.

14. The system of claim 9, wherein the condition of the refuse cart comprises a lid of the refuse cart being in an open position, and wherein modifying the collection routine comprises adjusting a height of the actuator arms of the grabber assembly before translating the actuator arms towards the refuse cart and engaging the refuse cart with the actuator arms.

15. The system of claim 14, wherein when the controller does not detect that the lid is in the open position, the controller is configured to translate the actuator arms towards the refuse cart at a first height, and when the controller detects that the lid is in the open position, the controller is configured to translate the actuator arms towards the refuse cart at a second height that is less than the first height.

16. The system of claim 9, wherein the condition of the refuse cart comprises at least one of the refuse cart being overfilled or the refuse cart experiencing a thermal event, and wherein modifying the collection routine comprises transmitting a notification to a user interface and pausing the collection routine until an input is received via the user interface.

17. A system for detecting and engaging a refuse cart, the system comprising:
a sensor coupled to a refuse vehicle, the sensor configured to generate sensor data indicative of objects on one or more sides of the refuse vehicle;
a lift assembly coupled to the refuse vehicle, the lift assembly comprising:
a grabber assembly comprising actuator arms that are configured to engage the refuse cart; and
a lateral actuator configured to adjust a lateral position of the grabber assembly relative to the refuse vehicle; and
a controller communicably coupled to the sensor and the lift assembly, the controller configured to:
determine, based on the sensor data, a first collection parameter comprising at least one of a width of the refuse cart, an orientation of the refuse cart, an alignment of the refuse cart with the grabber assembly, or a first obstruction in a vicinity of the refuse cart;
control the grabber assembly to adjust a distance between the actuator arms based on the first collection parameter; and
after causing the grabber assembly to adjust the distance, causing the lateral actuator to move the grabber assembly away from the refuse vehicle to engage the refuse cart.

18. The system of claim 17, further comprising a lift actuator assembly configured to adjust a vertical position of the grabber assembly, wherein the controller is further configured to:
determine, based on the sensor data, at least one second collection parameter comprising at least one of the first obstruction in the vicinity of the refuse cart, a second obstruction in the vicinity of the refuse cart, or a lid of the refuse cart in an open position;
cause the lift actuator assembly to adjust the vertical position of the grabber assembly based on the at least one second collection parameter before causing the lateral actuator to move the grabber assembly.

19. The system of claim 17, wherein the controller is further configured to:
determine, based on the sensor data, a third collection parameter comprising at least one of the first obstruction in the vicinity of the refuse cart or a third obstruction in the vicinity of the refuse cart, wherein the first obstruction or the third obstruction is detected behind the refuse cart relative to the refuse vehicle; and
determine a lateral distance to move the grabber assembly away from the refuse vehicle based on the third collection parameter, wherein moving the grabber assembly away from the refuse vehicle comprises moving the grabber assembly the lateral distance.

20. The system of claim 17, wherein the controller is further configured to:
detect, based on the sensor data, that the refuse cart is overfilled; and
reduce a collection speed of the lateral actuator based on detecting that the refuse cart is overfilled.
